(19) United States
(12) Patent Application Publication
(10) Pub. No.: US 2026/0288810 A1
(43) Pub. Date: Sep. 24, 2026

(54) SYSTEM

(71) Applicant: SoftBank Group Corp., Tokyo (JP)

(72) Inventor: Katsuhiro NAGAYAMA, Tokyo (JP)

(73) Assignee: SoftBank Group Corp., Tokyo (JP)

(21) Appl. No.: 19/567,033

(22) Filed: Mar. 14, 2026

(30) Foreign Application Priority Data
Mar. 19, 2025 (JP) 2025-045158

(51) Int. Cl. G06F 16/3329; G06F 3/04883; G06F 16/34; G06F 40/284; G10L 15/22

(52) U.S. Cl. CPC G06F 16/33295; G06F 3/04883; G06F 16/345; G06F 40/284; G10L 15/22

(57) ABSTRACT

A system includes a processor that is configured to generate a prompt for instructing a generative artificial intelligence model to generate an opinion based on an agenda of a meeting, acquire audio data and convert the audio data into text data, and analyze emotions of participants of the meeting based on the audio data or the text data and generate the opinion while taking the analyzed emotions into account.

### CROSS-REFERENCE TO RELATED APPLICATION

This application is based on and claims priority under 35 USC 119 from Japanese Patent Application No. 2025-045158 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional meeting support systems and decision support tools merely record discussions or provide generic analytical assistance, and therefore fail to generate context-aware, nuanced opinions that fully reflect the actual flow of a meeting. In particular, existing systems typically do not (i) generate prompts specifically tailored to meeting agendas for instructing a generative artificial intelligence model, (ii) seamlessly convert spoken discussions into text data suitable for further processing, and (iii) analyze emotions of meeting participants and incorporate the analyzed emotions into generated opinions. As a result, decision makers are unable to benefit from AI-generated opinions that consider both the explicit content and the emotional tone of discussions. Furthermore, conventional systems do not effectively utilize the novelty of AI-based board participation or AI-generated opinions to create topical interest and to improve branding or sales activities through external transmission of such opinions or meeting outcomes. Accordingly, there is a need for a system that can end-to-end support meetings by generating agenda-based prompts for a generative artificial intelligence model, converting audio data into text data, analyzing participant emotions, generating emotionally-aware opinions, and leveraging such opinions and outcomes for external communication to produce business effects.

### SUMMARY

In order to solve the aforementioned problems, the present invention provides a system comprising a processor, wherein the processor is configured to generate a prompt for instructing a generative artificial intelligence model to generate an opinion based on an agenda of a meeting, acquire audio data and convert the audio data into text data, and analyze emotions of participants of the meeting based on the audio data or the text data and generate the opinion while taking the analyzed emotions into account. The processor may be further configured to acquire content of the meeting by accepting manual input from an information management department or by automatically capturing the content of the meeting using a speech recognition technique, thereby enabling flexible and comprehensive acquisition of meeting information. Moreover, the processor may be configured to transmit the generated opinion or an outcome of the meeting to an external destination in order to create topical interest in an innovative initiative and to produce a sales effect, so that the system not only supports internal decision making but also contributes to enhancement of brand value and generation of business opportunities.

The term “processor” refers to a hardware or virtual computation unit, such as a central processing unit (CPU), graphics processing unit (GPU), digital signal processor (DSP), microcontroller, or a combination of such units, that executes instructions to perform the functions described in the present specification and claims.

The term “agenda of a meeting” refers to information indicating one or more topics, items, or issues scheduled to be discussed or decided in a meeting, including at least a title or label of each topic and optionally a description, background information, or objectives related to each topic.

The term “prompt” refers to data, typically in the form of text or structured information, that is provided as input to a generative artificial intelligence model in order to instruct the model regarding a task to be performed, a context to be considered, or a format or style of output to be generated.

The term “generative artificial intelligence model” refers to a machine learning model, such as a large language model, multimodal model, or other generative model, that is configured to generate new data, including text, audio, images, or other content, based on input data such as prompts, context information, or training data.

The term “opinion” refers to information generated by the system that expresses an assessment, recommendation, proposal, judgment, or analysis regarding a meeting agenda or meeting content, and that may include reasons, risk evaluations, or suggested actions.

The term “audio data” refers to digital data representing sound, including voice signals of meeting participants, recorded or captured in analog form and converted to digital form, and including, for example, streaming audio, stored audio files, or packetized audio segments.

The term “text data” refers to character data or symbolic representations of language obtained by converting audio data into text through speech recognition or by receiving manual textual input, and is suitable for processing by natural language processing or other analytical techniques.

The term “meeting participants” refers to persons or entities who attend or are deemed to attend a meeting, including but not limited to directors, executives, employees, external experts, and optionally an artificial intelligence agent treated as a participant for the purposes of analysis and opinion generation.

The term “emotions of participants of the meeting” refers to affective states, such as satisfaction, dissatisfaction, agreement, disagreement, confidence, anxiety, excitement, or other emotional or attitudinal indicators, inferred from speech, text, or other signals associated with meeting participants.

The term “analyze emotions” refers to processing operations that estimate, classify, or quantify emotional states of meeting participants, using techniques such as sentiment analysis, emotion recognition, prosody analysis, or other machine learning or rule-based methods applied to audio data, text data, or both.

The term “information management department” refers to a department, team, or role within an organization responsible for managing information related to meetings or business operations, including but not limited to secretariat staff, administrative staff, or information systems personnel who input or manage meeting content.

The term “speech recognition technique” refers to a method or system for converting spoken language contained in audio data into text data, including automatic speech recognition (ASR), voice transcription, or similar technologies implemented by software, hardware, or a combination thereof.

The term “content of the meeting” refers to information representing the proceedings of a meeting, including spoken statements, questions, answers, opinions, decisions, and other communications exchanged among meeting participants, in any captured form such as audio data or text data.

The term “outcome of the meeting” refers to information indicating results produced by a meeting, such as resolutions, decisions, action items, conclusions, summaries, or other outputs that reflect the final or intermediate status of discussions on one or more agendas.

The term “external destination” refers to a recipient or target system outside the internal environment of the meeting or the organization conducting the meeting, including external servers, media platforms, client systems, or external users, to which generated opinions or meeting outcomes are transmitted.

The term “topical interest” refers to attention, curiosity, or public or industry interest generated by dissemination of information about the use of the system, including the novelty of employing a generative artificial intelligence model to generate meeting-related opinions.

The term “sales effect” refers to a beneficial impact on business activities, such as increased inquiries, improved brand recognition, acquisition of new customers, or growth in revenue opportunities, resulting at least in part from external transmission of generated opinions or meeting outcomes.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

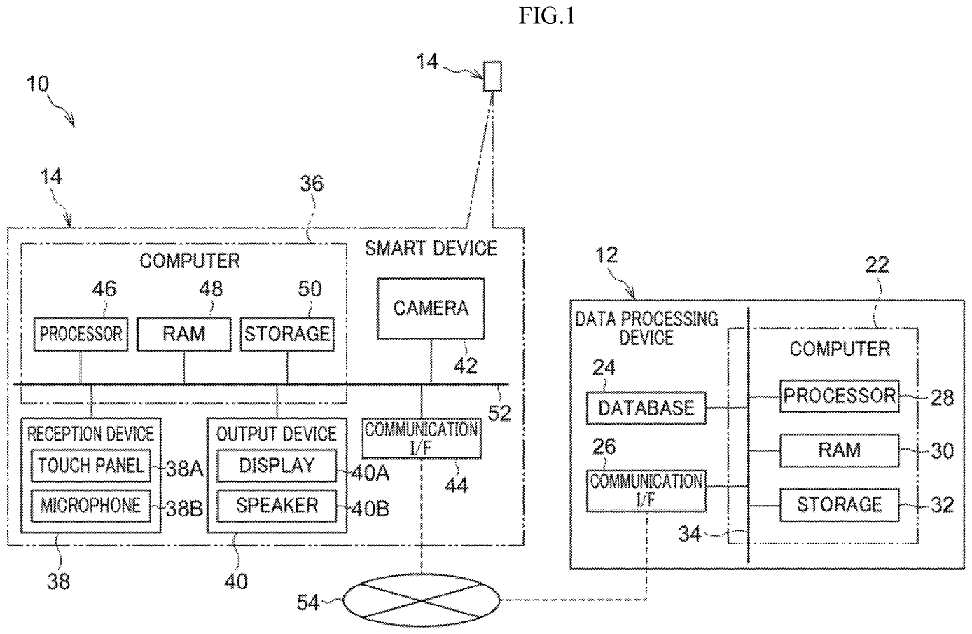

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

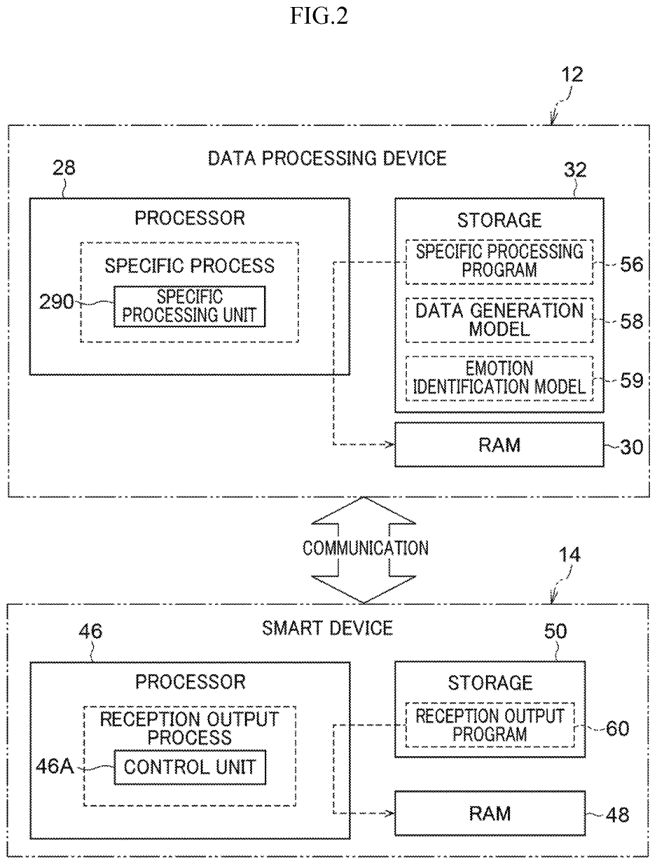

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented meeting support systems typically provide only simple recording or transcription of meeting content, or at most static recommendations based on predefined rules. Such systems do not fully leverage modern generative artificial intelligence models and do not optimize how textual meeting data is prepared and supplied to such models. As a result, the generated output is often generic, misaligned with the precise context of the meeting, and not well adapted to the dynamic evolution of the discussion.

In particular, existing systems have several technical deficiencies. First, meeting information such as the agenda, the detailed discussion content, and participant reactions is generally passed to an external generative AI model as unstructured or minimally processed text. This leads to increased computational waste in the model, suboptimal use of limited input length, and degraded relevance of the generated opinion. Second, conventional systems treat user input, real-time voice streams, and handwriting input as separate modalities without coherently normalizing these inputs into a unified text representation specifically optimized for prompt construction. This fragmentation complicates downstream processing, introduces latency, and reduces the quality of the data supplied to the model.

Third, existing systems generally do not incorporate real-time emotional state analysis of participants into the generation pipeline in a technically integrated manner. Even when emotion analysis components exist, they are not used to systematically modify the prompt sentences supplied to the generative AI model, and thus the model cannot computationally adapt its responses to the emotional dynamics of the meeting. Fourth, prompt sentences are typically static, being constructed once at the beginning of a session, and are not dynamically updated based on incremental user instructions and new meeting content. This lack of dynamic prompt management results in outdated or redundant context being supplied to the model, which increases processing overhead and reduces the specificity and actionability of the generated opinions.

Fifth, prior systems do not maintain a structured, machine-usable history of prior prompts and generated opinions on a per-meeting basis for reuse in subsequent sessions. Without such structured recording and reuse, the system must repeatedly reconstruct context from scratch, resulting in increased computational load, longer response times, and inconsistent behavior across related meetings.

Accordingly, there is a need for an improved computer-implemented system and server architecture that: (i) conducts systematic pre-processing of meeting information to generate optimized prompt sentences for a generative AI model, (ii) unifies multiple input modalities into a normalized text representation, (iii) integrates emotional state analysis into the prompt construction process, (iv) dynamically updates prompt sentences during the meeting in response to additional user instructions, and (v) persistently stores and reuses prompt and opinion data on a per-meeting basis. Such a system should improve the technical functioning of the meeting support platform itself, by more efficiently utilizing computational resources, reducing unnecessary model invocations and token usage, and increasing the relevance, precision, and adaptability of the generated opinions in real time.

The specific processing by the specific processing unit 290 of the data processing device 12 in Example 1 is realized by the following means.

The present invention provides a server comprising a processor configured to summarize meeting information and extract important terms based on an agenda and discussion content of a meeting, to generate a structured prompt sentence including the summarized information and the important terms for instructing a generative information processing apparatus to generate opinion information, to acquire voice information and handwriting information, convert the acquired voice information and handwriting information into character information, and use the character information as the meeting information for construction of the prompt sentence, to transmit the prompt sentence including the agenda, the discussion content, the summary, and the important terms to an external generative information processing apparatus and to receive the opinion information generated by the external generative information processing apparatus, to dynamically update the prompt sentence during progress of the meeting based on an additional instruction sentence input from a terminal by a user and obtain additional opinion information corresponding to the additional instruction sentence from the external generative information processing apparatus, to analyze an emotional state of participants of the meeting and add an analysis result of the emotional state to the prompt sentence so as to cause the external generative information processing apparatus to generate the opinion information in consideration of the emotional state, and to store the prompt sentence and the opinion information as recording information on a per-meeting basis and reuse the recording information for construction of the prompt sentence in a subsequent meeting. This enables the server to technically improve the efficiency and quality of interaction with the generative information processing apparatus by supplying optimized, dynamically updated prompt sentences built from unified multimodal inputs and emotion-aware context, thereby reducing computational waste, improving relevance and responsiveness of generated opinions, and enhancing the overall performance of the computer-implemented meeting support system.

The term “processor” refers to a hardware information processing element, such as a central processing unit or an execution unit, configured to execute instructions and perform arithmetic, logic, control, and data processing operations in order to implement functions of the system.

The term “meeting information” refers to electronic data representing at least an agenda, discussion content, and related contextual information of a meeting, including text, audio-derived text, and handwriting-derived text.

The term “agenda” refers to structured information indicating one or more topics, issues, or items scheduled to be discussed or decided in a meeting.

The term “discussion content” refers to information representing statements, questions, proposals, and other exchanges made by participants during a meeting.

The term “summary” refers to text data generated by reducing the length and complexity of meeting information while preserving principal points and essential context of the meeting.

The term “important terms” refers to words, phrases, or expressions automatically extracted or identified from meeting information and determined to be of relatively high relevance to the agenda or discussion content.

The term “prompt sentence” refers to a text string or a set of text strings constructed to instruct a generative information processing apparatus to perform a specific processing task, including generation of opinion information, based on supplied context.

The term “generative information processing apparatus” refers to an information processing system, such as a generative artificial intelligence model, configured to generate new text or other data in response to an input prompt sentence.

The term “opinion information” refers to data generated by the generative information processing apparatus that expresses evaluations, recommendations, proposals, or viewpoints related to the meeting information.

The term “voice information” refers to audio data representing spoken utterances of meeting participants captured by a sound input device.

The term “handwriting information” refers to electronic data representing handwritten characters, symbols, or drawings input by a pointing device, pen device, or touch input device.

The term “character information” refers to electronic text data obtained by converting non-textual input, such as voice information or handwriting information, into a machine-readable character sequence.

The term “external generative information processing apparatus” refers to a generative information processing apparatus that is located outside the server, for example on another computing device or network service, and that communicates with the server over a communication network.

The term “additional instruction sentence” refers to a text-based command or request input by a user during a meeting, which modifies, refines, or supplements the instructions given to the generative information processing apparatus.

The term “terminal” refers to an information processing device, such as a personal computer, mobile terminal, or tablet device, operated by a user to input information to, and receive information from, the server.

The term “emotional state” refers to a condition or tendency of feeling, such as satisfaction, dissatisfaction, agreement, disagreement, tension, or calmness, inferred from participant behavior including voice, expressions, or other observable signals.

The term “analysis result of the emotional state” refers to data representing an outcome of computational processing of signals related to participants, indicating one or more estimated emotional states.

The term “recording information” refers to stored data that includes at least prompt sentences and opinion information associated with one or more meetings and that is retained in a storage device for later use.

The term “per-meeting basis” refers to a storage or management unit where data is grouped and associated with an individual meeting, such that information for different meetings is logically separated.

The term “subsequent meeting” refers to a meeting that occurs after a given meeting and is related in topic, context, or participants, and for which previously stored recording information can be reused.

The server implements embodiments of the invention using a combination of general-purpose hardware and specialized software modules. The server includes at least one processor, a main memory, a non-volatile storage device, a network interface, and optionally a hardware accelerator such as a graphics processing unit. The server executes an operating system, for example a UNIX-like operating system, and runs an application program implemented in a high-level language. The application program is organized into modules including an input normalization module, a natural language pre-processing module, a prompt construction module, a generative AI communication module, an emotion analysis module, and a recording and reuse module. The server communicates with one or more terminals over a communication network such as the Internet using protocols such as HTTPS.

The terminal is realized as an information processing device such as a smartphone, a tablet device, or a personal computer. The terminal includes a processor, a memory, a display unit, an audio input device, and a pointing or touch input device. The terminal executes an operating system such as a mobile operating system or a desktop operating system and runs a client application implemented as a native application or a browser-based application. The client application displays user interfaces, accepts user input, and transmits meeting information and additional instruction sentences to the server in a structured format over a secure network connection.

The user operates the terminal to input an agenda and discussion content of a meeting and to provide additional instruction sentences during the meeting. The user further observes opinion information displayed on the terminal and may selectively provide feedback or refinement instructions.

The server uses a natural language pre-processing module to process meeting information. The server loads meeting information from the memory or storage and executes a tokenizer, a part-of-speech tagger, and a named entity recognizer. In one embodiment, the server calls a library such as a statistical natural language toolkit to perform tokenization and part-of-speech tagging, and uses a trained sequence labeling model such as a bidirectional recurrent network or a transformer-based encoder for named entity recognition. The server converts raw meeting text into a token sequence, assigns syntactic categories to tokens, and detects entities including organization names, product types, geographic locations, and technical terms.

The server applies a keyword extraction algorithm to the tokenized and labeled meeting information. The server constructs a term-document matrix for each meeting and computes term weights using a statistical weighting scheme such as term frequency-inverse document frequency. The server selects terms whose weights exceed a predetermined threshold and treats these terms as important terms. The server may further combine statistical weighting with part-of-speech filtering so that nouns, noun phrases, and technical terms are prioritized as important terms, while common function words are discarded. By reducing the set of candidate terms to a minimal but representative subset, the server improves the efficiency of subsequent encoding and reduces input length for the generative AI model.

The server performs summarization of the discussion content by applying a sentence-level scoring algorithm. In one embodiment, the server computes vector representations of sentences using a neural encoder, such as the encoder part of a transformer network trained on text pairs. The server measures cosine similarity between sentences and applies a graph-based ranking algorithm to select a subset of sentences that maximize coverage of diverse content while minimizing redundancy. The server concatenates these sentences in original order to form a summary representing the principal points of the meeting. This summarized text is shorter than the original discussion content but retains essential semantics, thereby reducing the token load on the generative AI model and improving computational efficiency.

The server constructs a prompt sentence using the prompt construction module. The server retrieves the agenda, the summary, and the important terms, and inserts these elements into a template stored in memory. The template is defined so that the resulting prompt sentence explicitly specifies the role of the generative AI model, the required output structure, and constraints such as level of detail and coverage of subtopics. For example, the server generates a prompt sentence such as:
“You are an AI member of a corporate decision-making committee.

Agenda: New product market entry strategy.

Meeting summary: The board will decide how to enter the market with a new product, focusing on target segments, differentiation, and initial pricing.

Keywords: market entry; new product; target market; competitors; pricing strategy.

Based on the meeting summary and the keywords, generate multi-angle strategic opinions covering (1) target market selection, (2) competitive positioning, and (3) pricing strategy options. Provide concrete recommendations and explain the reasoning behind them.”

The server uses this prompt sentence as input for a generative AI communication module that interfaces with a generative AI model. In one embodiment, the generative AI model is a transformer-type neural network comprising multiple layers of self-attention blocks and feed-forward networks. The model maintains an embedding layer that converts tokens into vector representations, a positional encoding mechanism that injects order information, and stacked blocks that compute attention weights between tokens to capture contextual dependencies. The model is trained with a sequence-to-sequence objective function or an autoregressive language modeling objective function where the loss is defined as cross-entropy between predicted token distributions and ground truth tokens. The model parameters, including weight matrices for attention projections and feed-forward networks, are optimized using stochastic gradient descent variants such as Adam, with regularization techniques including dropout and layer normalization.

The server sends the prompt sentence to the generative AI model through a communication interface. The server converts the prompt sentence into a token sequence using a tokenizer consistent with the vocabulary of the generative AI model. The server transmits the tokenized prompt and model parameters such as maximum output length, temperature, and sampling strategy to a model execution service running either on the same hardware platform or on a separate computing node. The generative AI model performs forward propagation computations, including matrix multiplications and non-linear transformations, to compute output token probabilities. The model then generates an output token sequence representing opinion information. The server receives the generated opinion information as text data, decodes it from model tokens to characters, and stores it in the memory and storage.

The server acquires multimodal meeting input by integrating audio and handwriting sources. The server receives audio streams captured by microphones connected to terminals or meeting room equipment. The server encodes the audio signal using a codec such as a waveform encoder and segments the stream into analysis frames. The server applies an acoustic model such as a deep neural network based on convolutional and recurrent layers, which maps acoustic features such as Mel frequency cepstral coefficients to phonetic units. A language model, which may be implemented as an n-gram model or a recurrent network, predicts likely word sequences. A decoder combines the acoustic model and language model scores and outputs textual hypotheses representing recognized speech. The server treats the resulting text as part of the meeting information and feeds it into the same natural language pre-processing pipeline as manually entered text.

The server receives handwriting input from the terminal via a stylus or touch interface. The terminal captures stroke coordinates over time and transmits them to the server as vector data or renders them as bitmap images. The server applies a handwriting recognition engine, which may include a convolutional neural network for image-based recognition or a recurrent network for stroke-based recognition, to convert the handwriting information into character information. The server then normalizes the recognized characters and appends them to the meeting information text.

The server performs emotion analysis to compute an emotional state of participants. The server receives audio streams and optionally video data representing participants'speeches or behaviors. The server extracts acoustic features such as pitch, energy, and spectral shape, and visual features such as facial landmarks and eye movement. The server feeds these features into an emotion classification model, for example a neural network with multimodal fusion layers. The model outputs probability scores over emotion categories such as agreement, disagreement, satisfaction, and tension. The server aggregates these scores over time and generates an analysis result of the emotional state. The server then encodes this analysis result into textual descriptors or symbolic tags, such as “participants show high concern about pricing risk,” and inserts these descriptors into the prompt sentence. By including emotion-related tags, the server causes the generative AI model to condition its output on the emotional context, for example by recommending risk-mitigating strategies in situations of heightened tension.

The server dynamically updates the prompt sentence based on additional instruction sentences received during the meeting. The user operates the terminal to enter a follow-up instruction such as:
“Focus on differentiation strategies against competitor B in the online sales channel and propose three detailed marketing tactics.”

The terminal transmits this additional instruction sentence to the server. The server appends the additional instruction sentence to the existing prompt or reconstructs a new prompt sentence that incorporates both the original summary and the new instruction. The server may also include previously generated opinion information as context. The updated prompt sentence explicitly instructs the generative AI model to refine or narrow its output, thereby preventing redundant computation on previously resolved topics. Because the server maintains a structured internal representation of meeting context, including agendas, summaries, important terms, emotion tags, and prior model outputs, the server can construct minimal prompts that carry sufficient context without overloading the model's input capacity. This reduces token count, shortens inference time, and improves the responsiveness of the system.

The server stores prompt sentences and corresponding opinion information in a persistent storage device on a per-meeting basis. The server organizes records by meeting identifiers and associates each record with metadata such as timestamps, participants, and related agendas. The server maintains indices that allow retrieval of prior prompts and opinions based on topic similarity or agenda identity. When a subsequent meeting is held on a related agenda, the server retrieves prior prompts and opinions and uses them as initial context for new prompt construction. This reuse reduces the need to re-summarize large volumes of historical text and allows the generative AI model to produce consistent opinions across related meetings. As a result, the system improves computational efficiency and maintains continuity of decision-making support.

The server improves computer technology by optimizing the data structures and algorithms used to construct prompt sentences for the generative AI model. The server reduces the size and redundancy of model inputs by pre-processing text to produce summaries and important terms, thus lowering computational load on the model hardware and reducing latency. The server further reduces network bandwidth consumption by transmitting compact prompts instead of raw meeting transcripts. The unified processing of multimodal input (text, voice, handwriting) into normalized character information allows the server to apply a single, optimized pipeline, which avoids duplicated logic and simplifies memory management. The server's dynamic prompt updating mechanism prevents unnecessary reprocessing of previously analyzed content and ensures that the generative AI model focuses its computation on newly emerging issues. These improvements in processing speed, resource utilization, and relevance of output result from specific data handling and algorithmic choices, rather than from mere automation of human cognitive tasks.

The server uses rule-based components and learned models in a non-conventional combination. For example, the server employs a rule-based filter to enforce constraints on prompt structure, a statistical keyword extractor to focus on salient terms, and a transformer-based generative model to produce opinion information. The server pre-defines a particular ordering of elements in the prompt sentence, such as role specification, agenda description, summarized content, keyword list, emotion tags, and explicit output requirements. This ordering has been selected to align with the attention mechanisms of transformer layers, such that high-priority context appears earlier in the token sequence and thus tends to receive greater attention weights. By designing prompt structure based on properties of the underlying neural architecture, the server achieves more stable and accurate generation than approaches that simply concatenate arbitrary text segments.

The server can be implemented in alternative embodiments. In one embodiment, the generative AI model resides on the same physical machine as the server application, and the server invokes the model through a local inference engine. In another embodiment, the generative AI model is provided as a remote service hosted on dedicated hardware accelerators, and the server communicates with it through an application programming interface. In yet another embodiment, the server uses different neural architectures for different tasks: a smaller transformer or recurrent network for summarization and keyword extraction, and a larger generative transformer for opinion generation. The server can select between models based on resource availability, meeting size, or latency constraints.

The terminal can provide different user interfaces in different embodiments. In one embodiment, the terminal displays meetings in a dashboard view, showing agenda items and the latest opinion information as separate sections. In another embodiment, the terminal displays AI-generated opinions side by side with real-time transcripts so that the user can compare and annotate content. The terminal may additionally highlight sections of opinion information that are derived from particular keywords or emotion tags, allowing the user to inspect how the server's pre-processing affected the generative output.

The user may employ the system in various technical contexts beyond board meetings, including design review sessions, incident response meetings in data centers, or operational planning conferences. In each context, the server processes sensor logs, event reports, and user annotations as meeting information and constructs prompt sentences tailored to the domain. The system thereby assists in evaluating configurations, selecting control parameters, or proposing remediation steps, and the improved processing pipeline leads to faster and more accurate computer-assisted decisions regarding real-world systems.

Through these embodiments, the server, the terminal, and the user cooperate to implement a meeting support system in which a generative AI model receives optimized, dynamically updated prompt sentences derived from unified multimodal meeting information and emotion-aware context. The technical structure of the system, including specific data transformations, neural network architectures, and prompt management algorithms, yields concrete improvements in processing speed, generation accuracy, and resource efficiency, and thus constitutes an improvement to computer technology itself.

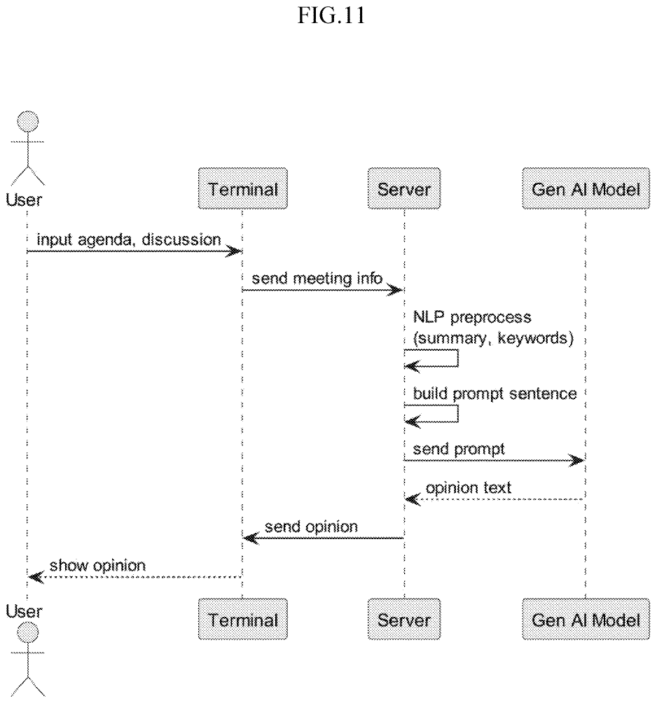

The following describes the processing flow using FIG. 11.

### Step 1:

The user operates the terminal to input meeting information. The terminal displays an input screen including fields for an agenda and discussion content. The user types text such as “New product market entry strategy” for the agenda and detailed discussion content describing required decisions regarding target market, competitors, and pricing. The terminal takes this raw keystroke input as the input data, converts it into a character string using the operating system's input subsystem, and structures it into an internal data object containing fields such as agenda, discussion text, and timestamp. The output of this step is structured meeting information on the terminal.

### Step 2:

The terminal transmits the structured meeting information to the server. The terminal takes the internal data object as input, serializes it into a text format such as JSON, and encapsulates it in an HTTPS request addressed to a predefined endpoint of the server. The terminal performs data processing that includes adding headers such as authentication tokens, meeting identifiers, and content type fields. The output of this step is a network message containing the meeting information, which is sent over a communication network to the server.

### Step 3:

The server receives and stores the raw meeting information. The server takes the HTTPS request as input through a network interface, decodes the encrypted communication, and parses the JSON payload to reconstruct the agenda and discussion content. The server performs validation checks, including verifying that the agenda is present and that the discussion content length does not exceed a configured limit. The server then executes a data operation to store this information in a persistent storage device, assigning a unique meeting ID and writing a record that includes the user ID, agenda, discussion text, and receipt time. The output of this step is a stored meeting record and an in-memory representation of the meeting information.

### Step 4:

The server performs natural language pre-processing on the meeting information. The server takes the in-memory agenda and discussion content as input to a natural language processing module. The server tokenizes the discussion content into sentences and words, applies part-of-speech tagging to classify each token, and runs named entity recognition to identify entities such as organizations, products, and locations. The server then applies a term weighting algorithm to compute term frequency-inverse document frequency values for tokens and multiword phrases and selects important terms whose weights exceed a threshold. In parallel, the server computes a summary by generating sentence embeddings, calculating pairwise similarities, and selecting a subset of sentences that maximize coverage while minimizing redundancy. The output of this step is a pre-processed data structure containing the agenda, the summary, and a list of important terms.

### Step 5:

The server constructs a prompt sentence for the generative AI model. The server takes the pre-processed data structure as input and inserts the agenda, summary, and important terms into a predefined prompt template stored in configuration data. The server performs string concatenation and formatting operations to assemble a single coherent text that instructs the generative AI model. The resulting prompt sentence may include explicit instructions about the role, required structure of the response, and focus areas. For example, the server may generate the following prompt sentence as output:
“You are an AI member of a corporate decision-making committee.
Agenda: New product market entry strategy.
Meeting summary: The board will decide how to enter the market with a new product, focusing on target segments, differentiation, and initial pricing.
Keywords: market entry; new product; target market; competitors; pricing strategy.
Based on the meeting summary and the keywords, generate multi-angle strategic opinions covering (1) target market selection, (2) competitive positioning, and (3) pricing strategy options. Provide concrete recommendations and explain the reasoning behind them.”

### Step 6:

The server acquires additional multimodal meeting input and normalizes it into text. The server takes audio signals captured by microphones and handwriting strokes captured by the terminal as input. The server processes the audio by segmenting the waveform into frames, extracting acoustic features such as Mel frequency cepstral coefficients, and applying a trained acoustic model and language model to decode the audio into text using speech recognition algorithms. The server processes handwriting by receiving stroke coordinates or images, applying a handwriting recognition model to classify character shapes, and converting them into character sequences. The server then performs data fusion by appending these recognized texts to the existing discussion content or storing them as separate text segments associated with timestamps and speakers. The output of this step is extended meeting information where audio and handwriting inputs have been converted into normalized character information ready for further language processing.

### Step 7:

The server integrates emotion analysis results into the prompt context. The server takes audio features, optional video features, and text transcripts as input to an emotion analysis module. The server runs a trained classifier that maps these features to probability distributions over emotion categories such as agreement, concern, or tension. The server aggregates results over time and computes a dominant emotional state or a distribution of states for the current segment of the meeting. The server then converts this numerical output into textual descriptors or symbolic tags, such as “participants show strong concern about pricing risk.”
The server performs a data operation to append these descriptors to the prompt sentence or to embed them as special markers, so that the emotional context becomes part of the instructions given to the generative AI model. The output of this step is an emotion-aware prompt sentence that includes both factual meeting content and emotional state descriptors.

### Step 8:

The server sends the constructed prompt sentence to the generative AI model and obtains opinion information. The server takes the emotion-aware prompt sentence as input, encodes it into tokens using a tokenizer corresponding to the vocabulary of the generative AI model, and calls a model inference interface. The server supplies model parameters such as maximum output length and sampling temperature and triggers execution of a transformer-based neural network on a model host. Inside this network, the prompt tokens are converted into vectors, and a series of matrix multiplications, attention weight computations, and non-linear activations are performed to compute output token distributions. The server receives the generated token sequence, decodes it back into text, and stores the resulting opinion information in memory and storage linked to the meeting ID. The output of this step is one or more opinion texts generated by the generative AI model.

### Step 9:

The server dynamically updates the prompt sentence based on additional instruction sentences from the user. The user operates the terminal to enter a refinement request such as “Focus on differentiation strategies against competitor B in the online sales channel and propose three detailed marketing tactics.” The terminal sends this additional instruction sentence to the server. The server takes the original prompt sentence, the newly received instruction sentence, and possibly the previous opinion information as input, and reconstructs an updated prompt sentence. The server performs textual operations that may include appending the instruction as a new section, inserting it into a “follow-up request” field, or restating the task description to narrow the scope. The server then sends this updated prompt sentence to the generative AI model using the same encoding and inference procedures as in the earlier step, and receives refined or additional opinion information. The output of this step is a new set of opinion texts that reflect the user's additional instructions while reusing the existing meeting context.

### Step 10:

The server prepares and transmits the opinion information to the terminal. The server takes the generated opinion texts and associated metadata, such as section titles and relevance scores, as input. The server may perform post-processing including segmentation into logical sections, addition of headings, and conversion into a structured format suitable for display.
The server then serializes this structured output into a transport format, encapsulates it in an HTTPS response, and sends it back to the terminal. The output of this step is a network message containing structured opinion information ready for presentation on the terminal.

### Step 11:

The terminal displays the opinion information to the user. The terminal takes the structured opinion data from the server as input and parses it into UI elements. The terminal renders headings, bullet lists, and paragraphs on the display, possibly with visual cues indicating which parts are linked to specific keywords or emotional states. The terminal may provide user interface controls that allow the user to scroll, collapse, or expand sections and select segments for copying or annotation. The output of this step is a visual presentation of AI-generated opinion information, enabling the user to review and utilize the content during the ongoing meeting.

### Step 12:

The server records prompt sentences and opinion information for reuse in future meetings.
The server takes each prompt sentence and its corresponding opinion information as input after generation. The server writes these as a pair into a database, associating them with the meeting ID, agenda, timestamps, and optional tags describing topic categories. The server may create indices on agenda terms and important terms so that similar meetings in the future can quickly reference these records. The server's data processing includes deduplication and compression operations to avoid redundant storage. The output of this step is a set of persistent recording records that can be retrieved later to accelerate prompt construction and improve consistency across related meetings.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional decision-support systems that use machine learning or rule-based logic to assist meetings and operational management often operate as isolated components that merely display analytical results or static schedules. In many cases, such systems require human operators to manually collect operational data, interpret complex outputs, and translate those outputs into executable instructions for controlled domains such as production facilities, service infrastructures, or information systems. As a result, the overall process from data acquisition to plan generation and execution remains fragmented and heavily reliant on manual coordination.

Furthermore, typical generative AI models are invoked with ad hoc or fixed prompt sentences that do not systematically incorporate real-time operational data, deviations from previous plans, or user feedback. This leads to suboptimal use of the model's capabilities, reduces the reliability of generated plans, and prevents continuous optimization based on accumulated edit histories and execution results. In addition, known systems generally do not integrate emotional state analysis of meeting participants with operational planning, and therefore cannot adapt their generated opinions to the human context in which operational decisions are made.

From a computer technology perspective, these limitations manifest as inefficient use of computing resources, redundant data processing pipelines, and an absence of closed-loop control between the planning logic and the operational environment. Processors in conventional systems process sensor streams, meeting content, and user edits in separate subsystems, without a unified orchestration that continuously updates a generative AI model's inputs and prompt sentences based on quantified differences between proposed and finalized plans. This architecture results in higher latency, inconsistent data states, and difficulty in maintaining or scaling the system.

Therefore, there is a need for a computer-implemented technique that integrates (i) real-time acquisition and preprocessing of time-series operational data, (ii) automatic generation and regeneration of structured prompt sentences for a generative AI model, (iii) generation of both meeting opinions and operation plans, (iv) user-interactive refinement on terminal devices with persistent edit histories, and (v) automatic translation of finalized plans into executable control instructions for a managed domain. Such a technique should improve the functioning of the computer system itself by providing an integrated processing pipeline that reduces manual intervention, ensures consistency between different data flows, and supports continuous optimization of the generative AI model's behavior based on feedback from execution results and user edits.

The specific processing by the specific processing unit 290 of the data processing device 12 in Application Example 1 is realized by the following means.

The present invention provides a server comprising a processor configured to generate a prompt sentence for a generative AI model based on agenda information of a meeting and state information of a managed domain so as to cause the generative AI model to generate an opinion and an operation plan; to acquire audio data from an acoustic input device or a recording medium, convert the audio data into character data, and extract utterance content and an emotional state of a meeting participant from the character data; to generate, by the generative AI model, an opinion relating to meeting management based on the extracted emotional state and the agenda information, and to perform preprocessing on time-series data acquired from the managed domain and input the preprocessed time-series data to the generative AI model to generate the operation plan relating to the managed domain; to acquire data indicating an operating state from a detection device installed in the managed domain, store the data in a storage device, and aggregate and normalize the data at predetermined time intervals to convert the data into an input format for the generative AI model; to transmit the operation plan output from the generative AI model to a terminal device and present the operation plan as visually displayable schedule information on the terminal device and as opinion information representing a rationale of the operation plan; to receive, via the terminal device, an edited operation plan edited by a user, verify an editing content, determine the edited operation plan as a final operation plan, and generate and transmit execution instruction information for a control device of the managed domain based on the determined final operation plan; and to record a difference between the operation plan and the final operation plan, regenerate the prompt sentence for the generative AI model based on new time-series data from the managed domain and the difference, and update the operation plan continuously. This enables an integrated, computer-implemented control loop in which the server automatically acquires and normalizes operational data, dynamically constructs and refines prompt sentences for the generative AI model, generates and explains operation plans, incorporates user edits captured on terminal devices, and converts finalized plans into executable control instructions, thereby improving the overall efficiency, responsiveness, and technical performance of the computer-based decision and operation management system.

The term “processor” refers to a hardware-implemented computation unit, such as a central processing unit or other data processing circuitry, configured to execute instructions and perform logical and arithmetic operations for implementing the functions described in this specification and claims.

The term “generative AI model” refers to a machine-implemented computational model that is configured to receive input data and generate new data or structured outputs, including but not limited to plans, schedules, or natural-language text, based on learned patterns from training data.

The term “prompt sentence” refers to a machine-readable natural-language or structured text input provided to a generative AI model, the content of which conditions or controls the type, context, or constraints of an output generated by the generative AI model.

The term “agenda information” refers to data representing topics, issues, or items scheduled for discussion or decision in a meeting, including associated metadata such as priorities, time frames, or responsible parties.

The term “meeting” refers to an event or session in which two or more participants exchange information, discuss topics, or make decisions, whether conducted in person, remotely, or in a hybrid manner.

The term “state information of a managed domain” refers to data representing a current or recent operational condition of a controlled environment, such as a production site, service infrastructure, or information system, including resource status, performance indicators, and constraint conditions.

The term “managed domain” refers to a physical or virtual environment whose operation is monitored and controlled by the server, including, for example, a manufacturing facility, a logistics network, a communication system, or an information processing system.

The term “opinion” refers to an information item generated by the generative AI model that expresses a recommendation, evaluation, or suggested action in relation to meeting management or operation planning.

The term “operation plan” refers to a structured representation of scheduled actions, resource allocations, or control settings for operating the managed domain over a specified time period.

The term “audio data” refers to digital representations of sound, including spoken utterances of meeting participants, acquired by an acoustic input device or read from a recording medium.

The term “acoustic input device” refers to an apparatus, such as a microphone or audio sensor, configured to capture sound and convert the captured sound into audio data.

The term “recording medium” refers to a machine-readable storage element, such as a magnetic, optical, or semiconductor memory, on which audio data or other information is stored for later retrieval.

The term “character data” refers to text-based data obtained by converting audio data or other input into symbolic representations such as characters, letters, or encoded strings.

The term “utterance content” refers to a textual or semantic representation of words, phrases, or sentences spoken by a participant, derived from character data produced by speech recognition or transcription.

The term “emotional state” refers to an inferred psychological condition of a meeting participant, such as sentiment or attitude, derived from analysis of audio data, character data, or other behavioral indicators.

The term “meeting participant” refers to an entity, such as a human user or automated agent, that contributes utterances or otherwise takes part in a meeting.

The term “meeting management” refers to a process of organizing, moderating, or guiding a meeting, including controlling agenda progression, supporting decision making, and summarizing or recording outcomes.

The term “time-series data” refers to data samples associated with time information, such as measurements or events collected at discrete or continuous time points in the managed domain.

The term “preprocessing” refers to one or more data processing operations applied to raw data, such as cleaning, filtering, aggregating, or normalizing, to transform the raw data into a form suitable for input to a computational model.

The term “detection device” refers to a sensing apparatus configured to obtain measurements or status information from the managed domain, such as operating state, performance metrics, or environmental variables.

The term “operating state” refers to a condition of equipment, processes, or resources in the managed domain, including statuses such as running, stopped, idle, error, or maintenance.

The term “storage device” refers to a hardware component or subsystem configured to store data, such as a memory device, a magnetic or solid-state drive, or a networked storage system.

The term “aggregate” refers to an operation of combining multiple data samples into summary values, such as sums, averages, counts, or other statistical measures, over a defined time interval or group.

The term “normalize” refers to a data transformation operation that adjusts the scale or distribution of data values, for example to fit within a predetermined numeric range or to have specific statistical properties.

The term “input format for the generative AI model” refers to a structured representation of data, such as numeric arrays, tokens, or encoded features, arranged according to predetermined dimensionality and encoding rules required by the generative AI model.

The term “terminal device” refers to a user-operable apparatus, such as a workstation, mobile device, or display unit, configured to communicate with the server, present information to a user, and receive user inputs.

The term “schedule information” refers to data that specifies temporal arrangements of operations or tasks, including start times, end times, resource assignments, and ordering in the managed domain.

The term “opinion information” refers to data representing explanatory or justificatory content, including rationales, reasons, or commentary associated with an operation plan or schedule.

The term “visually displayable” refers to a property of information that allows it to be rendered on a display unit in a human-perceivable graphical or textual form.

The term “user” refers to a human operator or authorized person who interacts with the terminal device to review, modify, or approve information relating to meeting management or operation planning.

The term “edited operation plan” refers to an operation plan that has been modified by a user through interaction with the terminal device, such as by changing times, assignments, or quantities.

The term “final operation plan” refers to an operation plan that has been determined by the processor as definitive for execution in the managed domain after verification of user edits.

The term “editing content” refers to information indicating modifications applied by a user to an operation plan, including added, removed, or changed elements.

The term “control device” refers to a hardware or software element configured to control operations in the managed domain, such as an actuator controller, a programmable controller, or an execution management component.

The term “execution instruction information” refers to data specifying commands, parameters, or setpoints to be applied by a control device in order to implement a final operation plan in the managed domain.

The term “difference between the operation plan and the final operation plan” refers to a representation of changes between an originally generated operation plan and a finalized operation plan, including additions, deletions, or modifications of scheduled items or parameters.

The term “new time-series data” refers to time-series data acquired after generation of an operation plan, representing updated or additional operational states of the managed domain.

The term “update the operation plan continuously” refers to a process in which the operation plan is periodically or event-drivenly regenerated or revised in response to new time-series data, differences between proposed and finalized plans, or other feedback.

In one embodiment, a server implements the claimed invention by executing a program stored in a non-transitory storage device. The server comprises at least one processor, a main memory, a network interface, and an interface to one or more detection devices and control devices in a managed domain. The server communicates with one or more terminal devices operated by a user via a communication network.

The server uses general-purpose computing hardware such as an instruction-executing processor, a volatile memory, and a non-volatile storage device. The server executes an operating system and application software modules implemented, for example, in a programming language such as Python running on a runtime environment. The server further uses a machine learning framework such as TensorFlow or a comparable numerical computation framework to implement and execute a generative AI model.

The server stores, in the storage device, program modules including a data acquisition module, a preprocessing module, a prompt generation module, a generative-model inference module, an opinion generation module, an operation-plan management module, a control-instruction generation module, and a logging and feedback module. Each module corresponds to functional elements recited in the claims and cooperates to realize the overall system behavior.

The server acquires time-series data from detection devices installed in the managed domain. The detection devices include, but are not limited to, sensors connected to industrial controllers, monitoring devices in information systems, or other measurement equipment. The server uses an industrial or system communication protocol to periodically read state information such as operating state identifiers, throughput counters, error codes, environmental measurements, and resource utilization values. The server formats the acquired measurements as records in a data structure, for example, relational tables or structured key-value groups, and stores these records into a database system such as a relational database management system.

The server performs preprocessing on the stored time-series data. The server uses a data-processing library such as Pandas and a numerical library such as NumPy to execute operations including noise filtering, missing-value imputation, time-based aggregation, and normalization. The server converts raw measurements into features that are meaningful for the generative AI model. For example, the server computes, for each time interval, aggregated metrics such as average throughput, utilization ratios, mean time between failures, and moving averages of error counts. The server performs normalization such as z-score standardization or min-max scaling to adjust these features into numerically stable ranges for neural network processing.

The server constructs input tensors for the generative AI model. The server arranges the above-mentioned features into multi-dimensional arrays, where one axis represents time steps, another axis represents different monitored resources or subsystems, and another axis represents feature types. The server stores the resulting arrays in a memory region accessible by the generative AI model.

In one embodiment, the server implements the generative AI model as a sequence-processing neural network. The server defines an architecture comprising an input embedding layer, one or more temporal encoding layers such as recurrent layers or attention-based transformer layers, and an output decoding layer that outputs structured representations of operation plans. The server may configure the model to include a multi-head self-attention mechanism to capture correlations across different resources and time steps, and feed-forward sublayers to transform intermediate representations. The server configures the output layer to produce, for each time slot and resource, probability distributions or scores over candidate operation states, such as which task to execute and at what intensity.

The server trains the generative AI model in advance using training data sets comprising historical time-series data and ideal operation plans. The server stores training data in the storage device and uses a supervised-learning procedure. The server defines a loss function such as a cross-entropy loss between predicted operation-state distributions and ground-truth operation labels, optionally combined with regularization terms encoding constraints such as resource capacities and temporal continuity. The server updates model parameters by gradient-based optimization such as stochastic gradient descent or an adaptive variant. The server computes gradients through backpropagation over the neural network graph and updates weight parameters in the memory of the computing hardware. The server may also apply data augmentation techniques such as temporal subsampling, noise injection, or synthetic disturbance patterns to improve robustness of the model to variations.

During deployment, the server uses the trained generative AI model for inference. The server loads trained model parameters from the storage device into main memory. The server supplies preprocessed feature tensors to the model, and the processor executes matrix multiplications, non-linear activation functions, and attention computations defined by the model architecture. The server obtains output tensors representing candidate operation plans, including assignments of tasks to resources across future time intervals.

The server further generates a prompt sentence for the generative AI model. The server constructs the prompt sentence as natural-language text that encodes meeting agenda information and current or recent operational conditions of the managed domain. The server retrieves agenda information from a meeting-management data structure or an input interface. The server retrieves recent operating results, abnormal events, requirements, and constraints from the database and summarizes them into concise textual descriptions. The server concatenates these descriptions into a structured prompt sentence.

For example, the server may generate a prompt sentence such as:
“Based on the following production status for the last 8 hours: Line 1 throughput 520 units, defect rate 1.2 percent; Line 2 throughput 430 units, defect rate 1.8 percent; Line 2 scheduled maintenance from 14:00 to 16:00; and the requirement to keep the defect rate below 1.5 percent, please propose an optimal operation plan for the next 24 hours that maximizes total throughput while satisfying these constraints.”

In another example, when a deviation from a previous plan occurs, the server may generate a prompt sentence such as:
“Line 1 has produced only 300 units in the last 4 hours versus the planned 400 units, and the defect rate has risen to 2.0 percent. Please generate an updated operation plan for the next 12 hours that compensates for this shortfall and minimizes overtime.”

The server inputs such a prompt sentence into a text-processing module of the generative AI model or into an auxiliary language model. The server tokenizes the prompt sentence, encodes tokens as vectors by an embedding layer, and combines this representation with encoded time-series features. The server thereby conditions the model output on both numeric state information and language-level constraints. This combined conditioning represents a non-conventional integration of meeting context and operational data, which enables the model to generate operation plans that are more aligned with explicit human-specified objectives and constraints.

The server also acquires audio data from an acoustic input device or from a recording medium. The server executes a speech-recognition engine to convert audio waveforms into character data. The server may implement acoustic feature extraction such as mel-frequency cepstral coefficients, feed these features into a neural speech-recognition model, and output transcribed text. The server then applies a sentiment-or emotion-analysis algorithm on the transcribed text. The server uses, for example, a classifier model trained to map linguistic patterns to emotional states such as positive, neutral, or negative. The server thereby extracts an emotional state of each meeting participant.

The server generates, by the generative AI model or by an associated language module, opinions relating to meeting management based on both the agenda information and the extracted emotional states. The server uses these opinions to adjust how suggestions and explanations are phrased, enhancing acceptance and clarity for human participants. The server stores such opinions in the storage device with timestamps and links to meeting identifiers.

The terminal device communicates with the server and presents information to the user. The terminal device may include a display unit, an input interface such as a touch panel or pointing device, and a network interface. The terminal device executes a client application or web browser to request schedule information and opinion information from the server. The terminal device renders a graphical representation of an operation plan, such as a timeline view with resource lanes and task segments. The terminal device also displays textual opinions and rationales generated by the server.

The user operates the terminal device to review and, when desired, edit the operation plan. The user may select individual tasks and adjust start times, end times, or resource assignments via the interface. The terminal device records such modifications in a local data structure, marking each changed element relative to the original plan. The terminal device transmits the edited operation plan and derived edit history to the server.

The server receives the edited operation plan and verifies the editing content by checking technical constraints. The server ensures that tasks assigned to each resource do not overlap beyond allowable tolerances, that resource capacities are respected, and that mandatory maintenance windows are not violated. The server may execute a constraint-checking algorithm that scans temporal sequences for conflicts and, if necessary, suggests automatic corrections. Once verification succeeds, the server designates the edited operation plan as a final operation plan and stores it in the storage device.

The server generates execution instruction information for control devices in the managed domain based on the final operation plan. The server translates each scheduled operation into device-level commands and parameters. The server formats these commands according to protocols supported by the control devices. The server schedules dispatch of such commands in accordance with the timing specified in the final operation plan. The server then transmits the commands to the control devices, which adjust machine states, service activations, or other controlled operations accordingly. In this way, the server directly controls physical or logical equipment in the managed domain based on plans derived from generative AI processing and human validation.

The server records the difference between the original operation plan generated by the generative AI model and the final operation plan approved by the user. The server constructs a difference representation that identifies added tasks, removed tasks, timing shifts, and parameter adjustments. The server stores this difference representation and associates it with corresponding initial plans, execution results, and contextual conditions.

The server uses new time-series data and the stored difference representation to regenerate prompt sentences and to adapt future operation plans. For example, the server may generate a prompt sentence indicating that prior AI-generated plans were consistently adjusted by the user to reduce load on specific resources during certain periods. The server then conditions the generative AI model with this information so that subsequent plans more closely approximate user preferences and practical constraints at the first inference. This reduces the amount of manual adjustment needed and shortens planning cycles.

The described structure yields technical improvements beyond mere automation of human planning. The server reduces communication load and processing latency by aggregating and normalizing time-series data at predetermined intervals and by storing preprocessed features in formats directly consumable by the generative AI model. The server improves computation efficiency by reusing trained model parameters across multiple planning cycles, performing incremental updates only when significant deviations or new conditions arise. The server improves data management by maintaining consistent relationships among raw sensor data, preprocessed features, generated plans, final plans, and differences, enabling auditability and efficient retrieval.

By integrating emotional-state analysis, agenda information, and real-time operational data into unified prompt sentences and model inputs, the server enables more accurate and context-aware generation of operation plans and opinions, which reduces erroneous or impractical recommendations. The server thus lowers the frequency of plan corrections and avoids unnecessary command transmissions to control devices. This, in turn, leads to reduced load on communication networks and control hardware.

In additional embodiments, the server may employ alternative neural network architectures, such as graph-based networks to capture interdependencies among resources, or convolutional structures to process local temporal patterns. The server may use different loss functions, such as multi-objective losses combining throughput, energy consumption, and service-level deviations. The server may also adapt learning methods, including reinforcement learning where the server observes rewards derived from actual execution (for example, meeting or exceeding performance targets) and updates policy parameters accordingly.

In other embodiments, the terminal device may implement local caching and partial validation logic to reduce round-trip communication with the server, thereby decreasing latency perceived by the user. The terminal device may also provide advanced visualization mechanisms such as interactive heat maps of resource utilization or overlays indicating past adjustment patterns, further enhancing the user's ability to evaluate AI-generated suggestions quickly.

Through these configurations, the server, the terminal device, and the user cooperate in a closed-loop system in which a generative AI model not only produces operation plans but also continuously adapts to real-world execution outcomes and user preferences. The system as implemented improves the functioning of the computer-based planning and control infrastructure itself, in terms of computational efficiency, accuracy of generated plans, and robustness of control over the managed domain.

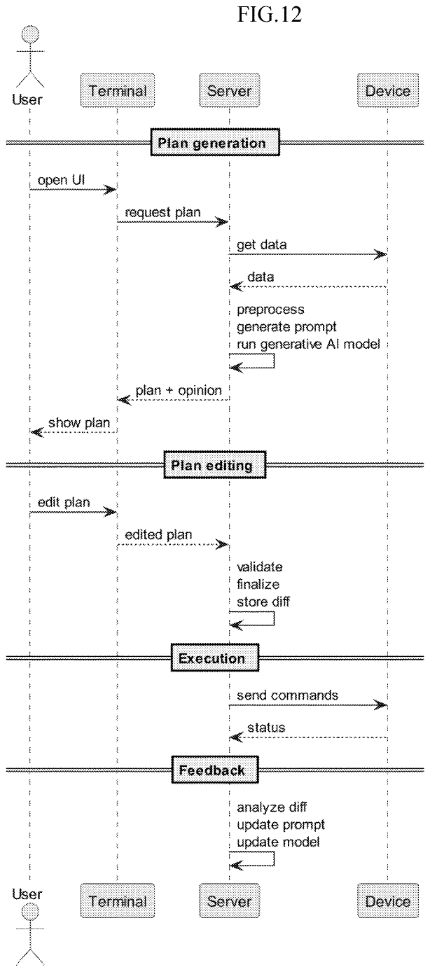

The following describes the processing flow using FIG. 12.

### Step 1:

The server acquires raw operational data from detection devices in the managed domain.
The input is sensor and status data transmitted from detection devices, including operating state flags, throughput counts, error codes, and resource usage values.
The server opens communication sessions using a predetermined protocol, reads current values from device registers or message frames, and attaches timestamps using the server clock.
The server converts the raw device-level data into structured records (for example, key-value maps with fields such as resource_id, timestamp, state_code, count_value) and stores the records in a database table.
The output is a set of time-stamped operational records stored in persistent storage and usable for later preprocessing.

### Step 2:

The server preprocesses and aggregates the stored time-series data.
The input is the set of raw time-stamped operational records retrieved from the database over a target period.
The server loads these records into a data-processing module, sorts them by resource and time, fills missing values using interpolation or last-observation-carried-forward methods, and discards records with impossible values such as negative counts.
The server groups records into fixed time windows (for example, 5 minutes) and computes aggregated metrics such as average throughput, utilization ratio, mean temperature, and error frequency for each resource and time window.
The server normalizes each metric by applying a scaling transformation so that feature values fall within ranges suitable for neural-network processing.
The output is a set of normalized feature vectors organized by resource and time window and stored as arrays or tensors in memory.

### Step 3:

The server constructs input tensors for the generative AI model.
The input is the normalized feature vectors produced by the preprocessing stage.
The server arranges the feature vectors into multi-dimensional arrays, where one dimension represents the sequence of time windows, another represents the set of resources, and another represents different features.
The server pads or truncates sequences as necessary so that all inputs have uniform length required by the model, and encodes categorical attributes (for example, resource types or mode labels) into numeric formats such as one-hot vectors.
The server stores the resulting arrays in a memory region accessible by the model-inference module.
The output is a batch of model-ready input tensors representing recent operational behavior of the managed domain.

### Step 4:

The server generates a prompt sentence that summarizes contextual conditions and requirements.
The input is agenda information of a meeting, recent operational statistics derived from the preprocessed data, and configuration data describing constraints and objectives.
The server extracts key values such as recent throughput per resource, defect rates, scheduled maintenance windows, and target performance thresholds.
The server combines these values with agenda topics such as “optimize next 24-hour schedule” or “recover from delay” and fills a predefined natural-language template.
The server, for example, generates a prompt sentence such as: “Based on the last 8 hours of operation, Resource A throughput 520 units, defect rate 1.2 percent; Resource B throughput 430 units, defect rate 1.8 percent; Resource B scheduled maintenance from 14:00 to 16:00; and a requirement to keep the defect rate below 1.5 percent, please propose an optimal operation plan for the next 24 hours that maximizes total throughput while satisfying these constraints.”
The output is a text string that constitutes a prompt sentence to be used for conditioning the generative AI model.

### Step 5:

The server analyzes meeting audio and extracts utterance content and emotional states.
The input is audio data captured by an acoustic input device or read from a recording medium during or after the meeting.
The server segments the audio into utterance units, computes acoustic features such as spectral coefficients, and feeds these features into a speech-recognition component to obtain transcribed character data.
The server then applies an emotion-classification model to the transcribed text and optionally to prosodic features, generating emotion labels or scores for each participant utterance.
The output is a set of records containing transcribed utterances and associated emotional-state indicators linked to participant identifiers and timestamps.

### Step 6:

The server encodes the prompt sentence and meeting-derived context for the generative AI model.
The input is the prompt sentence generated in Step 4 and the utterance and emotion records produced in Step 5.
The server tokenizes the prompt sentence into word or subword tokens, maps each token to an embedding vector, and optionally appends structured tags representing aggregated emotional context, such as “participants_show_concern” or “urgency_high.”
The server concatenates or otherwise integrates this contextual embedding with the time-series tensors prepared in Step 3, such that both numeric operational features and textual constraints are available at the model input.
The output is an augmented set of model input tensors and embeddings that encode both system-state information and human-context information.

### Step 7:

The server performs inference by the generative AI model to generate a candidate operation plan and meeting opinions.
The input is the augmented model input tensors and embeddings from Step 6.
The server feeds these inputs into the generative AI model, which executes a sequence-processing architecture comprising, for example, attention layers and feed-forward layers, to compute internal representations of future operation scenarios.
The server computes, for each resource and time slot, probability distributions over possible tasks or operation states and selects the most suitable tasks based on model scores and hard constraints such as capacity limits and maintenance windows.
The server also decodes part of the internal representation into natural-language sentences that express opinions about meeting management or the rationale of the generated plan.
The output is a structured candidate operation plan, including task assignments and time intervals, and a set of textual opinion sentences.

### Step 8:

The server converts the candidate operation plan into schedule information suitable for display.
The input is the structured candidate operation plan generated in Step 7.
The server transforms the plan into a data structure that includes, for each task, fields such as resource identifier, product or job identifier, planned start time, planned end time, and target quantity.
The server orders tasks chronologically per resource and checks for conflicts such as overlapping time segments; if minor conflicts are detected, the server resolves them using predetermined adjustment rules, for example by shifting start times within allowed slack.
The server then packages the refined plan into a format such as a JSON-like internal structure for transmission to terminal devices.
The output is schedule information with conflict-resolved task entries ready for visualization.

### Step 9:

The server transmits schedule information and associated opinion information to the terminal.
The input is the schedule information structure and the opinion sentences created in Steps 7 and 8.
The server formats the schedule and opinions into a response payload and sends the payload to the terminal via a network interface using a predetermined communication protocol.
The server may include identifiers linking opinion sentences to specific segments of the schedule, so that the terminal can display rationales next to corresponding tasks.
The output is network-transmitted data received by the terminal, including structured schedule information and explanatory text.

### Step 10:

The terminal receives and displays the schedule information and opinions for user review.
The input is the transmitted schedule and opinion payload from the server.
The terminal parses the received data, constructs in-memory representations of tasks, and draws a graphical schedule, for example, resource lanes with bars representing tasks over time.
The terminal displays textual opinions in association with schedule elements, such as tooltips or side panels, and allows the user to navigate, zoom, and filter the display.
The output is a visual representation of the operation plan and its rationale on the terminal display, accessible for interactive editing.

### Step 11:

The user reviews and edits the operation plan using the terminal interface.
The input is the displayed schedule and opinions as rendered by the terminal.
The user inspects task placements and resource loads, and uses interface controls such as drag-and-drop or form editing to change start times, end times, or resource assignments according to practical constraints or preferences.
The user may insert new tasks, delete tasks, or adjust quantities when necessary.
The output is an edited version of the operation plan residing in the terminal's local data model, with flags or markers indicating which elements differ from the original plan received from the server.

### Step 12:

The terminal transmits the edited operation plan and edit history to the server.
The input is the locally stored edited operation plan and associated edit markers.
The terminal constructs a data payload that includes, for each changed task, original parameters, new parameters, and the type of modification, such as “time_shift,” “resource_change,” or “quantity_adjustment.”
The terminal sends this payload to the server via the communication network using a request message of a predefined format.
The output is a message received by the server containing the edited operation plan and a detailed edit history.

### Step 13:

The server validates the edited operation plan and finalizes it as a final operation plan.
The input is the edited operation plan and edit history transmitted by the terminal.
The server runs a validation algorithm that checks for constraint violations, such as overlapping tasks on the same resource, exceeding capacity limits, or conflicting with fixed maintenance windows.
The server, if conflicts are detected, either automatically adjusts tasks within allowed margins or returns an error message for further user correction; if no unresolved conflicts remain, the server marks the edited plan as final.
The server then stores the final operation plan in the database together with metadata including user identifiers, timestamps, and a link to the original candidate plan.
The output is a validated final operation plan suitable for direct use in control-instruction generation.

### Step 14:

The server generates execution instruction information for control devices based on the final operation plan.
The input is the final operation plan approved and stored in Step 13.
The server transforms each scheduled task into device-level commands, mapping high-level job definitions to low-level parameters such as speed setpoints, activation flags, or configuration profiles for the control devices.
The server schedules the execution of these commands, for example by creating timed jobs that are triggered at specified start times.
The server encodes commands according to the communication protocol required by each control device and stores command queues in the storage device.
The output is a set of executable instruction messages queued for dispatch to the control devices.

### Step 15:

The server dispatches execution instruction information and monitors control-device responses.
The input is the queued instruction messages generated in Step 14.
The server transmits each command at or before the scheduled execution time to the corresponding control device and waits for acknowledgments or status responses.
The server logs the time of dispatch, acknowledgment receipt, and any reported execution errors; the server also updates internal state records to reflect whether tasks have been started, completed, or aborted.
The output is a log of executed commands and updated status records that reflect the actual progress of the operation plan in the managed domain.

### Step 16:

The server records differences between the candidate operation plan and the final operation plan and prepares data for future optimization.
The input is the original candidate operation plan from Step 7, the final operation plan from Step 13, and the edit history from Step 12.
The server computes a difference representation, identifying tasks that were added, removed, or modified, and calculating metrics such as the average magnitude of time shifts or resource reassignment frequency.
The server stores the difference representation and links it to contextual data such as operational conditions and meeting-agenda topics that were in effect when the plan was generated.
The output is a set of stored difference records that form part of a feedback data set used for adapting future planning behavior.

### Step 17:

The server generates updated prompt sentences and, when appropriate, new operation plans using accumulated feedback.
The input is new time-series data representing recent operational performance and the stored difference records from Step 16.
The server identifies recurring patterns in user modifications, such as consistently reduced load on certain resources during specific periods, and encodes these patterns as additional constraints or preferences in newly generated prompt sentences.
The server, for example, generates a prompt sentence such as:
“In recent planning cycles, tasks on Resource C have been repeatedly shifted to Resource D during night hours due to noise constraints. Taking this preference into account, and based on the last 6 hours of operation data, please propose an operation plan for the next 18 hours that maintains low utilization of Resource C between 22:00 and 06:00.”
The server reuses the generative AI model, now conditioned by the updated prompt sentences and current operational data, to generate revised candidate operation plans that better reflect real-world constraints and historical user behavior.
The output is a new or updated candidate operation plan and associated opinions, which reenter the cycle of display, editing, and execution.
It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented meeting support systems mainly focus on recording audio, generating static transcripts, or performing simple keyword extraction. Such systems typically treat speech recognition, text storage, and later analysis as loosely coupled and batch-oriented processes. As a result, these systems do not provide real-time, adaptive support for decision-making during an ongoing meeting and fail to exploit the capabilities of modern generative AI models in a technically efficient manner.

First, conventional systems generally lack a mechanism in which a server dynamically structures and refines prompt sentences to a generative AI model based on live, accumulating character data obtained from speech recognition. Prompt generation is often manually crafted, fixed, or external to the core processing pipeline. This causes technical inefficiencies, including redundant data transfers, sub-optimal use of model context windows, and increased latency in returning useful opinions and proposals to client terminals.

Second, existing systems typically do not integrate emotional state estimation of meeting participants into the computational pipeline in a way that affects how prompt sentences are constructed or how AI-generated opinion information is formatted. Emotional signals, such as stress, disagreement, or confusion, are often ignored or only handled at the user interface layer, rather than being used at the server side to adapt the behavior of the generative AI model. This leads to a mismatch between the actual interaction state of the meeting and the behavior of the underlying information processing system, and limits the system's ability to generate context-appropriate, technically relevant suggestions.

Third, many meeting tools require a user to explicitly trigger separate analysis operations, resulting in sporadic and delayed calls to AI services. The server does not automatically decide, based on the size or timing of the accumulated transcript, when to segment text, when to construct prompt sentences, and when to invoke the generative AI model. This lack of autonomous control logic causes unnecessary computational load, sub-optimal batching of speech recognition results, and slow response times for real-time decision support.

Fourth, conventional systems often store transcripts and AI outputs in an unstructured or weakly structured manner, making it difficult for the server to reconstruct comprehensive reports, structured summaries, and externally shareable artifacts without significant post-processing. This creates technical burdens on both storage and retrieval operations, and prevents the system from efficiently reusing already generated analysis results as structured data.

Therefore, there is a need for an improved computer-implemented system and server that (i) automatically acquires audio information from a terminal in segmented form, (ii) converts the audio information into character information at the server, (iii) dynamically constructs and updates prompt sentences for a generative AI model using the accumulated character information and meeting conditions, (iv) estimates emotional states of participants and uses those emotional states to adapt the prompts and output formats, and (v) stores character information and AI opinion information in a structured, meeting-centric manner so that real-time decision-making and post-meeting reporting are both technically efficient. Such an improvement should enhance the performance, responsiveness, and usefulness of the underlying computer system itself, rather than merely automating a human mental process.

The specific processing by the specific processing unit 290 of the data processing device 12 in Example 2 is realized by the following means.

The present invention provides a server comprising a processor and a communication interface, wherein the processor is configured to receive, via the communication interface, segmented meeting audio information transmitted from an information acquisition terminal, convert the received meeting audio information into meeting character information using a speech recognition function, accumulate the meeting character information in association with a meeting identifier, monitor an amount or time span of the accumulated meeting character information, and, when a predetermined condition is satisfied, extract a predetermined range of the meeting character information and generate a prompt sentence by embedding the extracted meeting character information into an instruction text including constraint conditions, the prompt sentence being configured to instruct a generative AI model to generate opinion information including summary information and specific action plans; transmit, to the generative AI model, input data including the prompt sentence and the extracted meeting character information, receive from the generative AI model an analysis result based on the input data, and generate the opinion information from the analysis result; estimate, from utterance content and response patterns included in the meeting character information, an emotional state of at least one meeting participant, and dynamically adjust at least one of content of the prompt sentence and an expression format of the opinion information based on the estimated emotional state; and record, in a structured storage, the meeting character information and the opinion information while associating the meeting character information and the opinion information with the meeting identifier, and, after the meeting is finished, reconfigure recorded contents as comprehensive report information and provide the comprehensive report information and at least a part of the opinion information to a meeting participant terminal and to an external information distribution apparatus. This enables technical improvement of computer-implemented meeting support by allowing the server to autonomously manage streaming audio-to-text conversion, to efficiently construct and adapt prompt sentences to a generative AI model based on live transcript segments and emotional state estimation, to reduce latency and redundant processing in real-time opinion generation, and to maintain structured, meeting-centric records that support both immediate decision-making at the terminal and efficient generation of reusable meeting reports.

The term “processor” refers to a hardware or virtual information processing unit, such as a central processing unit or a computing core executed by a virtual machine or container, that executes instructions to perform the functions described in the claims.

The term “communication interface” refers to a hardware and software combination that enables data exchange between the server and an external device or network, including wired or wireless network interfaces and associated communication protocols.

The term “information acquisition terminal” refers to an information processing device having at least an audio input function and a communication function, such as a portable terminal, a desktop terminal, or a dedicated meeting terminal, which captures meeting audio information and transmits the captured information to the server.

The term “meeting audio information” refers to digital data representing sound generated during a meeting, including speech of participants and other acoustic signals relevant to the meeting.

The term “segmented meeting audio information” refers to meeting audio information that has been divided into portions according to a predetermined condition, such as a time interval, a data size, or a logical boundary, so that each portion can be processed independently.

The term “speech recognition function” refers to a software-implemented or hardware-accelerated function that converts audio information into character information representing the linguistic content of the audio, using techniques such as acoustic modeling, language modeling, and decoding.

The term “meeting character information” refers to character-based data, such as text in a natural language, obtained by converting meeting audio information through the speech recognition function and optionally post-processing the resulting text.

The term “meeting identifier” refers to information, such as an identifier or label, that uniquely associates meeting audio information, meeting character information, and opinion information with a particular meeting session.

The term “accumulated meeting character information” refers to meeting character information that has been successively generated and stored for a given meeting over time, so that the stored information collectively represents at least a part of the meeting.

The term “predetermined condition” refers to a rule or threshold, such as a character count, a time duration, or a combination of multiple parameters, that, when satisfied, triggers a specific processing step such as generating a prompt sentence or calling a generative AI model.

The term “predetermined range of the meeting character information” refers to a subset of accumulated meeting character information, selected according to a rule such as a time window, a character length limit, a topic boundary, or a position within the transcript.

The term “instruction text” refers to character information that specifies processing to be performed by the generative AI model, including directions, constraints, output formats, and tasks to be executed on the input data.

The term “constraint conditions” refers to conditions included in the instruction text that limit or control behavior of the generative AI model, such as output length limits, language requirements, structural requirements, or style restrictions.

The term “prompt sentence” refers to a text sequence that includes at least the instruction text and the meeting character information, and that is used as input to the generative AI model to cause the generative AI model to generate an output in accordance with the included instructions and data.

The term “input data” refers to data transmitted to the generative AI model, including at least the prompt sentence and optionally additional parameters such as model configuration values or context information.

The term “generative AI model” refers to a trained information processing model, such as a neural network or large language model, that receives input data and generates new character information, including analyses, summaries, opinions, and proposals.

The term “analysis result” refers to output information returned from the generative AI model in response to the input data, the output information including at least an interpretation or transformation of the meeting character information according to the instruction text.

The term “opinion information” refers to information generated by the processor based on the analysis result from the generative AI model, including at least summary information, specific action plans, recommendations, or proposals related to the meeting content.

The term “summary information” refers to information that condenses and abstracts the meeting character information, representing main points, topics, or decisions of the meeting in a reduced character sequence.

The term “specific action plans” refers to information indicating concrete operations to be executed after the meeting, such as tasks, responsible entities, deadlines, and procedural steps inferred from the meeting character information.

The term “meeting participant terminal” refers to an information processing device used by a meeting participant, having at least a display function and a communication function, which receives and displays opinion information and, optionally, transmits control or feedback information to the server.

The term “emotional state” refers to an estimated internal state of a meeting participant, such as satisfaction, dissatisfaction, agreement, disagreement, stress, or confusion, inferred by analyzing utterance content, response patterns, or other observable signals.

The term “utterance content” refers to the semantic and linguistic content of spoken words of a meeting participant, as represented in the meeting character information.

The term “response patterns” refers to temporal, structural, or statistical patterns in the behavior of a meeting participant during a meeting, including timing of utterances, frequency of interruptions, or patterns of agreement and disagreement, as inferred from meeting audio information or meeting character information.

The term “expression format of the opinion information” refers to a presentation style or structure of the opinion information, such as layout, level of detail, tone, ordering of elements, or use of bullet points, that can be altered according to the emotional state or other conditions.

The term “structured storage” refers to a storage system, such as a database or data management system, that maintains information according to a predefined schema, enabling association, indexing, and retrieval of meeting character information and opinion information by identifiers and attributes.

The term “comprehensive report information” refers to information generated from recorded meeting character information and opinion information, including at least a consolidated transcript, summaries, decisions, unresolved issues, and recommended actions for the entire meeting.

The term “external information distribution apparatus” refers to an information processing device or service outside the meeting participant terminals, such as a server system or publication system, that receives structured information and provides it to users other than the participants of the meeting.

The term “meeting outcome” refers to a result of a meeting, including decisions, agreements, action items, and analyzed summaries, as represented by structured information generated and stored by the system.

In one embodiment, the system includes a server, at least one terminal, and at least one user who participates in a meeting. The server includes a processor, a memory, a structured storage device, and a communication interface connected to a communication network. The terminal includes an audio input unit such as a built-in microphone, a display unit, a user input unit, a local memory, and a communication module. The user operates the terminal during an actual meeting in a physical conference room or a remote conferencing environment.

The terminal uses its audio input unit and an operating system level audio capture library, such as an audio recording framework in a mobile operating system or a sound capture application programming interface in a desktop operating system, to acquire analog sound waves of the meeting and convert the analog sound waves into digital meeting audio information. The terminal uses a pulse-code modulation scheme with a predetermined sampling rate and bit depth, for example, a 16-bit linear pulse-code modulation format at 16 kHz. The terminal partitions the audio samples into segments according to a time-based segmentation rule, for example, a segment length of 5 seconds or 10 seconds, and stores each segment in a local buffer as segmented meeting audio information. The terminal associates each segment with metadata including at least a meeting identifier, a terminal identifier, and a time stamp.

The terminal uses its communication module, for example, a wireless communication device such as an IEEE 802.11 wireless local area network interface or a cellular data communication module, to transmit the segmented meeting audio information and the associated metadata to the server via the communication network. The terminal transmits the segments using a secure protocol such as a hypertext transfer protocol over transport layer security. The terminal receives acknowledgements from the server and manages retransmission or buffering in response to a communication delay or failure. The use of segmentation reduces the size of each transmission unit, thereby reducing peak bandwidth usage and allowing the server to begin processing before the entire meeting has finished.

The server receives the segmented meeting audio information via the communication interface. The server uses a web server framework and an application framework, such as a general-purpose HTTP server and a web application framework written in a high-level programming language, to parse the transmitted data and store each segment in the structured storage device. The structured storage device is configured to store audio segments in association with the meeting identifier and the time stamp. The server maintains an index table that maps each meeting identifier and time interval to the corresponding audio segment, thereby allowing efficient random access to specific portions of the meeting.

The server converts each audio segment into meeting character information using a speech recognition function. The server may use a software library or an external speech recognition service that implements an acoustic model and a language model. In one embodiment, the acoustic model is a deep neural network that receives time-frequency features such as Mel-frequency cepstral coefficients or log-Mel filter bank features extracted from the audio samples. The server calculates the features for each audio frame by applying a short-time Fourier transform, a Mel-scale filter bank, and a logarithm operation. The deep neural network may be a recurrent neural network, a convolutional neural network, or a transformer-based architecture trained on large amounts of speech data with corresponding text labels. The language model may be an n-gram model or a transformer-based model that scores candidate token sequences. The server decodes the acoustic likelihoods and language model scores using a beam search algorithm to obtain a most probable sequence of characters or words as the meeting character information.

The server accumulates the meeting character information in the structured storage device. The server maintains, for each meeting identifier, a transcript object that includes a time-ordered list of character sequences, each character sequence linked to the corresponding audio segment and time range. The server updates the transcript object incrementally as new audio segments are transcribed. This incremental update allows the server to maintain an up-to-date representation of the meeting in textual form while distributing computation over time rather than processing a single large audio file at the end of the meeting. The incremental approach reduces peak memory requirements and shortens latency between speech and availability of the corresponding text.

The server monitors an amount of accumulated meeting character information, for example, a number of characters, a number of tokens, or a time duration covered by the transcript. The server applies a predetermined condition to decide when to construct a new prompt sentence for a generative AI model. For example, the server determines that when at least 1,000 characters or 2 minutes of meeting time have been added to the transcript since the last analysis, a new prompt sentence should be generated. The server also considers a context window limit of the generative AI model, for example, a maximum number of tokens that can be processed in a single request. The server uses these conditions to select a predetermined range of the meeting character information, such as the last N tokens or the transcript portion corresponding to a current agenda item.

The server constructs an instruction text that defines a task to be performed by the generative AI model, constraint conditions, and a desired output structure. The instruction text may include specifications such as a maximum number of bullet points, a requirement to output both pros and cons, or a requirement to propose concrete deadlines. The server then embeds the selected meeting character information into the instruction text to form a prompt sentence. For example, the server may generate a prompt sentence such as:
“You are a generative AI model assisting in a live project planning meeting.

Read the following recent transcript section.
1. Summarize the discussion about the next release deadline in no more than 5 bullet points.
2. List the pros and cons of extending the deadline.
3. Propose two concrete deadlines and justify each in 2-3 sentences.

Transcript:

[here the server inserts the latest meeting character information].”

The server may also prepare another example of a prompt sentence for a final comprehensive analysis, such as:
“Please analyze the entire meeting transcript below. Provide:
(1) an overall summary,
(2) key decisions made,
(3) unresolved issues, and
(4) recommended next steps.

Transcript:

[here the server inserts the full meeting character information].”

The server sends the prompt sentence and any necessary configuration parameters as input data to the generative AI model. In one embodiment, the generative AI model is a transformer-based large language model that has been trained on a large corpus of text using a self-supervised learning method such as next-token prediction. The model includes multiple layers of multi-head self-attention, feed-forward sublayers, and layer normalization units. The model converts each token of the input data into an embedding vector, applies positional encoding, and computes attention scores between tokens to generate contextualized representations. The model uses learned weight matrices and activation functions such as rectified linear units or Gaussian error linear units to propagate information through the layers.

The generative AI model has been trained using a training set of input-output pairs, and a loss function such as a cross-entropy loss between predicted tokens and ground-truth tokens. During training, a gradient-based optimization algorithm such as stochastic gradient descent or an adaptive optimizer updates the model's weights to minimize the loss. The training may also use data augmentation methods, such as varying text order, masking tokens, or injecting noise, in order to improve generalization. These training details allow the model to generate coherent and context-sensitive text when the server supplies a new prompt sentence and transcript.

The server receives an analysis result from the generative AI model. The analysis result is a sequence of tokens decoded into natural language text. The server parses the analysis result according to the structure defined in the instruction text, for example, by detecting headings, bullet points, or delimiter phrases. The server separates portions corresponding to summary information, pros and cons, risk information, and specific action plans. The server stores the opinion information in the structured storage device as structured records linked to the meeting identifier and time ranges of the transcript that were used to generate the analysis. The server thus maintains a meeting-centric data structure that includes both the raw transcript and layered analyses, allowing efficient retrieval and re-use of these analyses in subsequent operations or for reporting.

The server further estimates an emotional state of at least one meeting participant based on utterance content and response patterns included in the meeting character information. In one embodiment, the server uses a sentiment classification model that receives text segments and outputs a discrete label or continuous scores representing emotional categories such as positive, negative, neutral, agreement, or disagreement. The sentiment classification model may be a neural network trained using a supervised learning algorithm. The server additionally calculates temporal features such as speaking rate, interruption frequency, and turn-taking patterns by examining time stamps of utterances in the transcript. The server uses a rule set or a learned classifier to combine these features into an estimated emotional state.

The server modifies at least one of content of the prompt sentence and an expression format of the opinion information based on the estimated emotional state. For example, if the emotional state indicates high disagreement and negative sentiment, the server adjusts the instruction text to ask the generative AI model to highlight conflicting points and propose compromise options. The server may also instruct the generative AI model to use concise and neutral language. This adaptation is performed by changing parameter values or adding conditional instructions within the prompt sentence, which results in output that is structurally different and technically more aligned with the meeting dynamics than a fixed, non-adaptive prompt would produce. This interaction between emotional state estimation and prompt sentence construction is executed at the server using concrete algorithms and data structures, thereby improving the behavior of the computational system itself.

The server records all meeting character information, opinion information, and associated metadata in the structured storage device with indexing by meeting identifier, time range, and type of information. The server uses a relational data model or a document-oriented data model with explicit schemas for transcripts, segment links, and analyses. The server can later reconstruct a comprehensive report for the entire meeting by retrieving related records and combining them according to time order and logical sections. The comprehensive report includes at least the full transcript, multiple levels of summaries, decision lists, unresolved issues, and recommended next steps. The server outputs the comprehensive report to the terminal and, optionally, to an external information distribution apparatus such as an enterprise information system or a document management system.

The terminal presents the opinion information and the comprehensive report on its display unit. The terminal uses graphical user interface components such as panels, lists, and highlighted text segments to enable the user to view summaries, browse detailed transcript portions, and inspect proposed action plans. The terminal may allow the user to select an opinion item and request display of the underlying transcript text that gave rise to that item. The user reads the opinion information and interacts with other participants in the meeting, but the technical processing of acquisition, transformation, and analysis of data is performed primarily by the server and the terminal as described above.

The combination of segmented audio transmission, incremental speech recognition, dynamic prompt sentence construction, emotional state-based adaptation, and structured storage provides technical improvements beyond a simple automation of human tasks. The server reduces end-to-end latency by distributing computation across the duration of the meeting, instead of performing all analysis after the meeting has ended. The server reduces communication and computation overhead by choosing an appropriate predetermined range of meeting character information that fits within the generative AI model's context window and by reusing previously generated opinion information. The server improves accuracy and relevance of generated opinions by conditioning the generative AI model on fine-grained transcript segments aligned with current agenda items and emotional states. The structured storage and indexing scheme improve data management efficiency by enabling direct access to specific segments and associated analysis without scanning entire logs.

The system uses an architecture and processing flow that differ from conventional human-centric workflows. The server does not simply replicate a human summarizer's work; instead, the server uses explicit segmentation rules, model context management rules, and emotional adaptation rules that are defined in terms of computational constraints, such as token limits and latency targets. The generative AI model, the speech recognition function, and the sentiment classifier collectively implement an algorithmic pipeline that optimizes for throughput, accuracy, and stability under real-time conditions. The use of neural networks trained with specific loss functions and weight update rules, along with explicit data structures for transcripts and opinions, results in a computer system that operates in a technically improved manner in comparison to a system that merely records audio or stores text without such coordinated processing.

In another embodiment, the server uses a locally deployed generative AI model executed on a hardware accelerator such as a graphics processing unit or a tensor processing unit. The server loads model weights into the accelerator memory and processes batches of prompt sentences for multiple meetings in parallel. The server uses a scheduling algorithm to assign incoming analysis requests to accelerator resources in a manner that minimizes idle time and maximizes throughput. In yet another embodiment, the server uses different generative AI models for intermediate and final analyses, for example, a smaller model for frequent real-time updates and a larger model for a final comprehensive report. The server may also apply post-processing techniques such as topic clustering of transcript segments or automatic detection of agenda transitions using unsupervised learning methods. These alternative configurations illustrate that the invention can be implemented using different hardware and software components while preserving the core technical features of dynamic prompt sentence generation, adaptive analysis, and structured storage centered on meeting character information and opinion information.

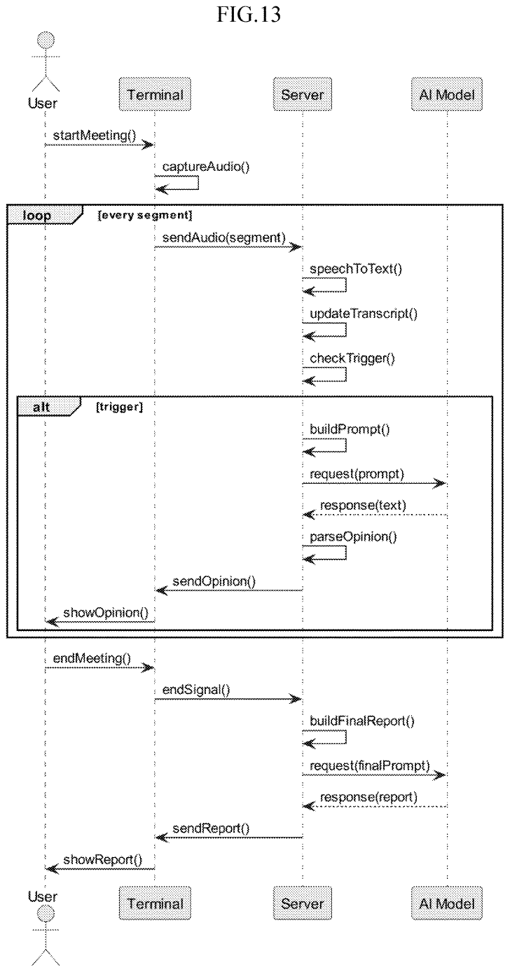

The following describes the processing flow using FIG. 13.

### Step 1:

The user activates a meeting application on the terminal and initiates audio capture. The terminal displays a start control, receives a user input to begin recording, and requests microphone access from the operating system if required. The input of this step is a user operation indicating a start of a meeting. The terminal uses its audio input hardware and an audio capture library to convert analog sound waves from the meeting into digital samples, applies pulse-code modulation at a predetermined sampling rate and bit depth, and outputs a continuous stream of meeting audio information into an in-memory buffer.

### Step 2:

The terminal segments the buffered meeting audio information into fixed-length units. The input of this step is the continuous stream of digital audio samples generated in Step 1. The terminal applies a time-based rule, for example, a 5-second window, and divides the stream into discrete segments by counting samples according to the sampling rate. The terminal associates each segment with metadata including a meeting identifier, a terminal identifier, and a time stamp, and outputs segmented meeting audio information objects ready for transmission.

### Step 3:

The terminal transmits each segmented meeting audio information object to the server via a communication network. The input of this step is the segmented meeting audio information and the associated metadata produced in Step 2. The terminal encapsulates the segment data and metadata into a network message, establishes a secure channel using a transport protocol such as HTTPS, and sends the message to a server endpoint. The terminal receives an acknowledgment from the server and, based on the acknowledgment status, either discards successfully delivered segments or retains and retries failed segments. The output of this step is a sequence of network messages received by the server and an updated local buffer state on the terminal.

### Step 4:

The server receives the segmented meeting audio information and stores it in structured storage. The input of this step is the network message containing a segment of meeting audio information and the metadata from Step 3. The server uses a communication interface and a web application framework to parse the message, extracts raw audio bytes, the meeting identifier, and time stamps, and stores the audio segment in a storage device while registering an index entry linking the meeting identifier and time range to the stored location. The output of this step is a persistent audio segment record and an updated index table that can be used for subsequent retrieval and processing.

### Step 5:

The server converts each stored audio segment into meeting character information using a speech recognition function. The input of this step is the audio segment and its metadata from Step 4. The server applies a feature extraction algorithm to the audio samples, such as computing frames, applying a short-time Fourier transform, generating Mel-frequency filter bank energies, and applying logarithmic scaling. The server feeds the resulting feature vectors into a trained acoustic model and language model, executes a decoding algorithm such as beam search to select the most likely sequence of tokens, and outputs a text string representing the linguistic content of the segment as meeting character information. The output of this step is a character sequence associated with the original time range.

### Step 6:

The server accumulates the meeting character information and maintains a transcript structure for each meeting. The input of this step is the character sequence output from Step 5 and the meeting identifier. The server appends the new character sequence to a transcript data structure, which may be implemented as a time-ordered list of segment entries including text and time stamps. The server updates cumulative statistics such as total character count, token count, and time coverage, and outputs an updated transcript object that reflects the current state of the meeting text.

### Step 7:

The server determines whether to trigger a new analysis by a generative AI model based on accumulated transcript metrics. The input of this step is the updated transcript object and threshold conditions such as minimum character count and minimum time interval since the last analysis. The server compares current metrics to the threshold values, checks whether the generative AI model context window can accommodate a candidate transcript range, and decides whether to initiate generation of a new prompt sentence. The output of this step is a decision result indicating either a trigger to construct a prompt sentence or a decision to wait for additional data.

### Step 8:

The server selects a predetermined range of meeting character information to be embedded into a prompt sentence. The input of this step is the transcript object and a trigger decision from Step 7. The server applies a selection rule, for example, extracting the most recent N tokens, selecting text corresponding to a current agenda segment, or trimming text so that the total token count remains within a model-specific limit. The server may also use markers that denote agenda transitions to define segment boundaries. The output of this step is a selected text block representing the portion of the meeting to be analyzed by the generative AI model.

### Step 9:

The server estimates an emotional state of at least one meeting participant based on the accumulated meeting character information. The input of this step is the transcript object or the selected text block from Step 8. The server segments the text into utterances, identifies speaker labels if available, and calculates linguistic features such as sentiment scores, modality usage, and intensity indicators. The server may feed the text into a sentiment classification model to obtain probability scores for categories such as agreement, disagreement, or stress, and may compute temporal features based on time stamps, such as speaking rate and interruption frequency. The output of this step is an emotional state estimate associated with one or more participants and time ranges.

### Step 10:

The server constructs an instruction text and integrates the selected meeting character information and emotional state into a prompt sentence. The input of this step is the selected text block from Step 8 and the emotional state estimate from Step 9. The server chooses a prompt template that defines required outputs, constraints, and formatting, and modifies the template based on the emotional state, for example, by including directives to emphasize conflict resolution or risk mitigation. The server concatenates the modified instruction text and the selected transcript as a single sequence, and outputs a prompt sentence ready to be supplied to the generative AI model. For example, the server may output a prompt sentence such as:
“You are a generative AI model assisting in a live project planning meeting.
Read the following recent transcript section.
1. Summarize the discussion about the next release deadline in no more than 5 bullet points.
2. List the pros and cons of extending the deadline.
3. Propose two concrete deadlines and justify each in 2-3 sentences.
Transcript:
   [latest meeting character information].”

### Step 11:

The server composes input data for the generative AI model and transmits it to a generative AI inference engine. The input of this step is the prompt sentence from Step 10 and configuration parameters such as maximum token count and temperature. The server tokenizes the prompt sentence according to the vocabulary of the generative AI model, packs the token sequence into a request object including model parameters, and sends the request via a communication interface to a model execution environment, which may be a remote service or a local model running on an accelerator. The output of this step is a model request containing encoded tokens and configuration, which initiates execution of the generative AI model.

### Step 12:

The server receives an analysis result from the generative AI model and derives opinion information. The input of this step is the token sequence or text output from the generative AI model produced in response to the request from Step 11. The server decodes tokens to text if required, parses the text according to the structure specified in the instruction portion of the prompt sentence, and extracts fields such as summary information, pros and cons, risk descriptions, and specific action plans. The server may apply pattern matching or simple parsing rules to identify labeled sections. The output of this step is structured opinion information that can be stored and displayed.

### Step 13:

The server stores the opinion information and links it to the corresponding meeting character information in structured storage. The input of this step is the structured opinion information from Step 12 and the transcript metadata. The server creates database records or structured documents that associate each opinion item with the meeting identifier, time range, and the prompt configuration used to generate it. The server updates index structures that support retrieval by topic, time, or type of suggestion. The output of this step is an updated meeting-centric data structure that contains both raw transcript segments and layered analytical results.

### Step 14:

The server prepares display data for the terminal using the stored opinion information. The input of this step is the structured opinion information and, optionally, a request from the terminal for updated analysis results. The server formats the opinion items into a representation suitable for a user interface, such as an ordered list of summaries, labeled decision candidates, or risk lists, and may include references to transcript segments for drill-down. The server encapsulates the formatted data into a response message, and outputs the message for transmission to the terminal through the communication interface.

### Step 15:

The terminal receives the display data and presents it to the user. The input of this step is the response message containing formatted opinion information from Step 14. The terminal parses the message, maps fields to user interface components such as text views and interactive lists, and renders the summaries, proposals, and other analytical content on the display. The terminal may associate selectable controls with each opinion item to allow the user to request more detail or view related transcript excerpts. The output of this step is a graphical presentation of analysis results visible to the user.

### Step 16:

The user reviews the displayed opinion information and optionally interacts with specific items. The input of this step is the visible content on the terminal's display. The user may select an item indicating a proposed action, request display of underlying transcript text, or mark a suggestion as accepted or rejected. These user operations result in additional input events to the terminal.

### Step 17:

The terminal transmits user feedback or selection information to the server, and the server updates meeting records accordingly. The input of this step is a set of user interaction events from Step 16. The terminal encodes the events into messages and sends them to the server. The server receives the messages, interprets them as feedback regarding the corresponding opinion items, and updates stored records to reflect user decisions or relevance scores. The output of this step is an updated set of meeting outcome data that captures which generated opinions were utilized, providing material for improved reporting and potential model adaptation in future implementations.

### Step 18:

The user terminates the meeting session on the terminal, and the server generates a comprehensive meeting report from stored transcript and opinion information. The input of this step is a user operation indicating meeting end and the complete set of stored meeting character information and opinion information. The server retrieves all transcript segments and associated analyses for the meeting identifier, orders them by time, and combines them into a consolidated document. The server may construct a final prompt sentence that requests the generative AI model to produce a high-level summary, list key decisions, and identify unresolved issues using the full transcript, and may then process the result as in Steps 11 and 12. The server compiles the comprehensive report and outputs it to the terminal and, if configured, to an external information distribution apparatus for archival or broader distribution.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented decision support systems suffer from several technical limitations when processing real-time conversational data and heterogeneous operational data. First, typical systems treat speech recognition, natural language analysis, and emotion estimation as independent pipelines, so that prompt sentences supplied to a generative AI model are static and insensitive to the actual emotional state of participants. As a result, opinion outputs of the generative AI model can be poorly aligned with user context, leading to repeated user corrections, inefficient human-machine interaction, and increased processing overhead in both network usage and computation cycles.

Second, conventional systems generally feed raw or minimally summarized business, operational, or advertising data into analytical components without dynamically conditioning such data according to current conversational context or user reactions. This often forces client devices or downstream applications to perform additional local filtering and restructuring of outputs, increasing latency and resource consumption at the edge and degrading end-to-end responsiveness of the overall computing environment.

Third, most existing architectures do not use feedback signals—such as user approvals, corrections, or inferred emotional states—to automatically adapt subsequent prompt generation strategies or update learning information of the generative AI model. In such systems, prompts are handcrafted and static, which can cause sub-optimal token usage, unnecessary model calls, and poor convergence of model behavior over time. From a computer-technology standpoint, this leads to inefficient use of processing resources in the server and network, and prevents the system from optimizing its own inference workflow based on runtime feedback.

Fourth, when supporting complex domains such as operation management of moving objects, enterprise management decisions, production optimization, and advertising planning, conventional systems either handle each domain in a separate siloed application or rely on manual integration by operators. This siloed design leads to redundant processing steps, duplicated data transformations, and incompatible interfaces, thereby increasing memory footprint, CPU load, and network traffic in the distributed computing infrastructure.

Accordingly, there is a need for an improved computer-implemented system and server architecture that (i) tightly integrates speech recognition, emotion analysis, and generative AI inference, (ii) dynamically generates and adjusts prompt sentences in response to both conversational content and detected emotional states, (iii) automatically combines emotion-aware opinion information with heterogeneous operational data to generate actionable support information, and (iv) uses user feedback and emotional context as runtime signals to adapt prompt generation logic and learning information of the generative AI model. Such a system should reduce unnecessary processing, improve output quality, and enhance the efficiency and responsiveness of decision support workflows on general-purpose computing hardware.

The specific processing by the specific processing unit 290 of the data processing device 12 in Application Example 2 is realized by the following means.

The present invention provides a server comprising a processor configured to generate, based on agenda information of a meeting or other discussion, a prompt sentence for a generative AI model that instructs the generative AI model to generate opinion information; to acquire audio data representing speech in the meeting or other discussion and convert the audio data into character data by performing speech recognition processing; to analyze, by executing emotion estimation processing, an emotional state of one or more participants based on at least the character data and the agenda information, and in accordance with the emotional state to adjust content of at least one of the prompt sentence to be input to the generative AI model and opinion information obtained from the generative AI model, thereby generating emotion-aware opinion information; to acquire at least one of operation information of a moving object, business information of an organization, operation information of a production environment, and information relating to advertising, and to combine the acquired information with the emotion-aware opinion information and the emotional state to generate support information relating to at least one of operation management, business decision-making, production optimization, and advertising planning; to present the support information to an output device or a display device, to receive an approval input or a correction input from a user with respect to the support information, and in accordance with the approval input or the correction input to update at least one of the operation management, the business decision-making, the production optimization, and the advertising planning; and to update, based on at least one of the support information, the approval input or the correction input, and the emotional state, a generation method of the prompt sentence for the generative AI model or learning information for the generative AI model so as to improve accuracy of generation of the opinion information in subsequent processing. This enables a computer-implemented decision support workflow in which the server dynamically tailors prompt sentences and generative AI outputs to real-time conversational and emotional context, efficiently fuses such outputs with heterogeneous operational data, and adaptively refines its own inference behavior using runtime feedback, thereby reducing computational waste, lowering end-to-end latency, and improving the technical performance and usability of decision support operations executed on general-purpose computing hardware.

The term “processor” refers to one or more hardware computation units, such as a central processing unit, a graphics processing unit, or a programmable logic device, that execute instructions to perform data acquisition, data transformation, analysis, control, or output processing in the system.

The term “generative AI model” refers to a machine-implemented information processing model, including but not limited to neural network models, that receives input data or instructions and generates new information such as text, numerical values, or structured data based on learned parameters.

The term “prompt sentence” refers to a sequence of characters representing an instruction, query, or context description that is supplied as input to a generative AI model to cause the generative AI model to generate corresponding output information.

The term “agenda information” refers to data describing topics, issues, items, or objectives that are intended to be discussed or decided in a meeting or other discussion.

The term “meeting” refers to a communication session in which a plurality of participants exchange information or opinions regarding at least one agenda, regardless of whether the session is held in person, remotely, or in a hybrid form.

The term “discussion” refers to an interaction in which one or more participants express opinions, questions, or proposals regarding one or more subjects, including but not limited to a meeting, briefing, or informal conversation.

The term “audio data” refers to digital data representing sound, including sampled waveforms, encoded audio streams, or any other computer-readable representation of sound captured from speech or other acoustic events.

The term “character data” refers to digital data representing textual information, including sequences of characters in any encoding that correspond to words, symbols, or other written expressions.

The term “speech recognition processing” refers to computer-implemented processing that converts audio data representing speech into character data representing the corresponding textual content.

The term “emotion estimation processing” refers to computer-implemented processing that analyzes data such as audio, text, or image information to infer an emotional state, sentiment, or affective category associated with a participant or content.

The term “emotional state” refers to a condition associated with a participant that is characterized by affective attributes such as happiness, sadness, anxiety, anger, calmness, frustration, or neutrality, and that is inferred using emotion estimation processing.

The term “participant” refers to any entity, including a human user or an automated agent, that is involved in a meeting or discussion by providing, receiving, or processing information.

The term “emotion-aware opinion information” refers to opinion information that has been generated or adjusted based at least in part on an estimated emotional state of one or more participants.

The term “opinion information” refers to generated information expressing an assessment, recommendation, proposal, or viewpoint relating to an agenda, subject, or operational matter.

The term “operation information of a moving object” refers to data describing the status, environment, or control of an object capable of moving, such as location, speed, route, schedule, or operation constraints.

The term “moving object” refers to any machine or apparatus that is capable of locomotion or displacement, including vehicles, robots, or mobile devices.

The term “business information of an organization” refers to data related to operations, performance, or resources of an organization, including sales data, cost data, customer data, and market data.

The term “operation information of a production environment” refers to data representing the state or performance of a production facility, including machine states, throughput values, defect counts, or sensor measurements.

The term “information relating to advertising” refers to data associated with advertising activities, including product descriptions, target audience data, campaign parameters, and advertisement performance metrics.

The term “support information” refers to information generated by the processor that is intended to assist in performing or improving operation management, business decision-making, production optimization, or advertising planning.

The term “operation management” refers to planning, controlling, monitoring, or adjusting operations of a moving object or system, including route selection, scheduling, and resource allocation.

The term “business decision-making” refers to selecting a course of action related to the management or strategy of an organization, based on available information, analyses, or recommendations.

The term “production optimization” refers to improving efficiency, throughput, quality, or resource utilization in a production environment by adjusting operational conditions or configurations.

The term “advertising planning” refers to designing, selecting, or arranging advertising activities, including campaign concepts, messages, channels, and schedules.

The term “support information relating to at least one of operation management, business decision-making, production optimization, and advertising planning” refers to information that provides recommendations, evaluations, or options to assist in performing any one or more of those activities.

The term “output device” refers to any hardware component that presents information to a user or external system, including a display, speaker, printer, or communication interface.

The term “display device” refers to an output device that visually presents information, such as a monitor, touchscreen panel, or projection apparatus.

The term “approval input” refers to an input signal, such as a command or user interface action, that indicates acceptance or confirmation of support information or a proposed action.

The term “correction input” refers to an input signal, such as an edited value, selection, or comment, that modifies or rejects at least part of the support information or a proposed action.

The term “generation method of the prompt sentence” refers to a procedure, rule set, or algorithm used by the processor to construct or modify a prompt sentence for the generative AI model.

The term “learning information for the generative AI model” refers to data used to train, adapt, or guide behavior of the generative AI model, including training data, fine-tuning data, configuration parameters, or control signals.

The term “subsequent processing” refers to one or more executions of opinion information generation, support information generation, or related operations performed by the processor after prior executions in which feedback or emotional states have been obtained.

The term “information management entity” refers to a person, group, or system that is responsible for inputting, maintaining, or supervising content information related to a meeting or discussion.

The term “terminal device” refers to a computing apparatus operated by a user or information management entity, such as a personal computer, tablet, smartphone, or dedicated terminal, that is capable of transmitting or receiving data to or from the server.

The term “input process” refers to processing in which the processor receives data from a user interface, a device, or another system, and stores or applies the data for further computation.

The term “external information providing apparatus” refers to a device or system outside the server that receives information for further distribution, display, storage, or processing, including external servers, client devices, or communication gateways.

The term “result information of the meeting or other discussion” refers to data summarizing outcomes of a meeting or discussion, such as decisions, action items, or resolutions.

The term “activity information relating to use of the generative AI model as a decision-making entity” refers to data describing when, how, and for what agenda the generative AI model was invoked to generate opinion information, and how such information was used in decision-making.

The term “public-relations information” refers to information that is formatted or selected to promote awareness, reputation, or interest regarding the system, an organization, or its activities.

The term “public interest” refers to attention, curiosity, or engagement from external viewers, customers, or stakeholders regarding information that is disclosed or communicated externally.

The term “business activities” refers to operations, transactions, or initiatives carried out by an organization for economic, commercial, or strategic purposes, including marketing, sales, production, and service provision.

According to one embodiment, a system includes a server and one or more terminals connected via a communication network. The server includes at least one processor and a memory storing instructions which, when executed by the processor, cause the server to perform the functions described below. The terminal includes a processor, a display device, and input interfaces such as a keyboard, a pointing device, a touchscreen, a microphone, and optionally a camera.

The server executes an operating system such as a general-purpose server operating system, and executes application software modules implemented, for example, in a programming language such as Python or another high-level language. The server uses standard hardware components including a central processing unit, a working memory, a non-volatile storage device, and one or more network interfaces. In some embodiments, the server additionally uses a graphics processing unit to accelerate neural network computation.

The server stores, in the memory, a plurality of functional modules, including at least: a speech acquisition module, a speech recognition module, a text processing module, an emotion estimation module, a prompt generation module, a generative-model interface module, a domain-data acquisition module, a support-information generation module, a feedback processing module, and a model-adaptation module. Each module is realized as a set of instructions and data structures, and respective modules cooperate via shared data structures stored in the memory.

The terminal executes a web browser or a native application that connects to the server via a protocol such as HTTPS. The terminal displays user interfaces provided by a web framework such as a client-side rendering framework, and sends user inputs and feedback to the server.

In one embodiment, the server uses a speech recognition engine. The speech recognition engine may be a cloud-based automatic speech recognition service, or an on-premise model.

The server supplies audio frames, encoded for example as 16-bit linear PCM at a sampling rate such as 16 kHz or 8 kHz, and receives recognized text segments as character data. The speech recognition module stores these text segments in a structured format, for example, as records in a transcript table, where each record includes fields such as a timestamp, a participant identifier, and a text string.

The server uses the text processing module to normalize the character data. The server applies tokenization, lowercasing, punctuation normalization, and optionally language-specific morphological analysis by means of a natural language processing library. The server stores the processed tokens and associated indices in a text index, which is a data structure mapping each token to positions in the transcript.

The server uses the emotion estimation module to estimate an emotional state for each participant. In one embodiment, the server uses a multimodal emotion model. The server supplies acoustic features derived from the audio data, such as Mel-frequency cepstral coefficients, pitch contours, and energy features, as well as textual features such as token sequences, to a neural network. The neural network may be implemented as a hybrid architecture combining a convolutional layer or recurrent layer for acoustic features and a transformer encoder layer for textual features. The network outputs, for each time segment and each participant, probability scores corresponding to emotion classes such as neutral, happy, sad, angry, and anxious. The server stores the emotion probabilities in an emotion state table with keys including participant identifiers and time intervals.

The server uses the prompt generation module to construct a prompt sentence for a generative AI model. The server retrieves agenda information for a meeting or other discussion from a database. The server also retrieves a segment of the transcript, and retrieves current emotion states from the emotion state table. The server combines these pieces of information into a textual instruction string in accordance with a predetermined template. The template includes fields for an explicit role instruction, a domain specification, summarized context, and a request for specific types of output. The server uses a deterministic procedure to determine which parts of the transcript to include, for example, a sliding time window or a selection of segments around emotion peaks, thereby reducing token length and improving computational efficiency.

In one embodiment, the server generates a prompt sentence such as: “We provide the following transcript excerpt of a management meeting and a summary of participants'emotions. Act as a decision support assistant. Based on this context, generate a concise recommendation regarding the next quarter's product pricing. The transcript: [condensed transcript]. Emotion summary: [Participant A appears anxious; Participant B appears frustrated]. Provide a recommendation, and explain in two paragraphs how your proposal addresses these emotions.”

In another embodiment relating to advertising planning, the server generates a prompt sentence such as:
“Create three novel advertising campaign ideas for our new smart fitness band. Target audience: men and women in their 20s and 30s who live in large cities and value social sharing and stylish design. For each campaign, output: 1) a short slogan, 2) a 2-sentence concept description, and 3) suggested visuals.”

In another embodiment relating to production optimization, the server generates a prompt sentence such as:
“Analyze the following production-line metrics and worker stress indicators for the last 4 hours. Identify the main bottlenecks, propose three operational changes to improve throughput by at least 10%, and suggest at least two actions to reduce worker stress without reducing output. Metrics: [tables]. Emotion data: [summary].”

The server uses the generative-model interface module to communicate with a generative AI model. The generative AI model may be implemented as a large-scale transformer neural network having multiple attention layers, feedforward layers, and layer normalization. The model is trained in advance via a supervised or unsupervised learning process on large corpora. The server sends the prompt sentence to the model by encoding it as a sequence of tokens, obtains output tokens from the model, and converts the tokens back to character data, thereby obtaining opinion information.

The server uses an explicit configuration of parameters such as a temperature parameter, a top-p parameter, and a maximum token count, to control randomness, diversity, and computational cost. The server may adjust these parameters dynamically based on the type of domain, the detected emotional state, or a quality estimate of previous outputs. For example, the server may reduce the temperature when a high-confidence, reproducible suggestion is desired in a safety-critical domain such as operation management of a moving object.

The server uses the domain-data acquisition module to retrieve domain-specific operational data. For operation management of a moving object such as a vehicle, the server retrieves position information from a location sensor or a communication interface, retrieves route information from a navigation database, and retrieves traffic information from an external traffic information service. For business decision-making, the server retrieves sales data, customer data, and market index data from a relational database or external application programming interfaces, and converts them into a standardized data structure such as a series of time-aligned arrays. For production optimization, the server retrieves sensor readings, machine state logs, and defect counts from a shop-floor control system via industrial protocols, and aggregates them into station-wise performance metrics. For advertising planning, the server retrieves product metadata, target segment descriptions, and historical campaign performance metrics from a marketing database.

The server uses the support-information generation module to fuse the emotion-aware opinion information with the domain data. The support-information generation module uses rule-based combination logic or a secondary model to integrate recommendations from the generative AI model with numeric constraints and status information extracted from the domain data. For example, in operation management of a moving object, the server evaluates suggested routes using a pathfinding algorithm or a constraint optimization algorithm, and discards options that violate time windows or safety constraints. In production optimization, the server checks feasibility of suggested scheduling changes against machine availability and shift rules.

The terminal receives support information from the server via the network. The terminal displays the support information as textual explanations and graphical visualizations. For example, the terminal may display recommended routes and current positions on an electronic map, may display predicted sales curves in a chart, or may display production bottlenecks as colored indicators on a line diagram. The terminal also presents interactive controls allowing a user to approve, reject, or modify the proposed support information. The terminal transmits the user's approval input or correction input back to the server.

The server uses the feedback processing module to record the user's approval inputs and correction inputs, together with the corresponding prompt sentences, the generative AI outputs, and the emotion states at the time of support information generation. The server stores these records in a feedback database for later use by the model-adaptation module. The feedback database contains structured data, such as identifiers for sessions, timestamps, user selections, ratings, and free-text comments.

The server uses the model-adaptation module to improve the generation of prompt sentences and the behavior of the generative AI model based on the feedback and emotion states. In one embodiment, the server performs prompt optimization without modifying the internal weights of the generative AI model. The server analyzes the feedback database using clustering and statistical analysis to identify patterns where particular prompt structures are associated with high approval rates or low correction rates. The server adjusts templates of prompt sentences accordingly, for example by adding explicit instructions about tone, output format, or the handling of specific emotions. This adaptation improves both the relevance of outputs and the computational efficiency, because unnecessary tokens and ambiguous instructions are removed, which reduces token length and model computation time.

In another embodiment, the server performs fine-tuning of a secondary model or a small adapter network associated with the generative AI model. The server constructs a training dataset that pairs prompt sentences with desired outputs derived from corrected opinion information or high-rated support information. The server uses a learning process such as gradient descent optimization of a loss function (for example, a cross-entropy loss or a sequence-level loss) to adjust the weights of the adapter network or to adjust bias parameters.

During training, the server uses techniques such as mini-batch processing, learning-rate scheduling, and data augmentation (for example, slight rephrasing of prompts) to stabilize learning. As a result, the generative AI model, when combined with the adapter, produces outputs that more closely match the decision patterns that users have historically approved, thereby increasing output accuracy and reducing the number of corrections required.

The server uses the emotion states not only to adjust prompts but also to condition the adaptation process. For example, the server may give higher weight to training examples where the emotion-aware opinion information successfully reduced negative emotions as inferred from post-decision emotion estimations. In this way, the system does not simply automate human decision-making, but uses quantitative emotion signals as part of a computer-internal optimization loop. This yields a non-conventional feedback pathway that reduces oscillations in user interactions and shortens the average number of iterations until an acceptable decision is reached.

In another embodiment, the server controls or influences physical devices in the real world. For example, when the support information relates to operation management of a moving object, and when a user approves a proposed route, the server sends control commands to a vehicle control system to change the target route stored in a navigation controller. In a production environment, when the support information relates to a schedule adjustment and receives approval, the server sends updated schedule parameters to a manufacturing execution system, which in turn changes machine start times and job dispatch orders. The causal connection between the improved computation and the control commands leads to measurable reductions in travel time, energy consumption, or machine idle time.

By integrating speech recognition, emotion estimation, prompt generation, and domain-specific computations in a coordinated architecture, the server reduces redundant data transfers and processing stages. For example, emotion estimation is performed based on compact feature vectors and aggregated probabilities, rather than repeatedly analyzing raw audio or video streams for each call to the generative AI model. Likewise, prompt generation uses compressed and contextually selected transcript segments, which reduces the length of prompts and the number of tokens the generative AI model must process. This directly decreases processor cycles and network bandwidth consumption, improving processing speed and reducing communication load.

The server thereby implements a specific data flow and module configuration that improves computer technology itself. Instead of applying a generative AI model in isolation, the server manages a dynamic prompt-control and feedback mechanism that trades off model usage and local deterministic computation. The server allocates tasks such that deterministic modules handle aggregation, constraint checking, and structural combination, while the generative AI model is invoked only for tasks that benefit from natural language generation. This reduces the number of high-cost inference operations and improves throughput.

The server also uses specialized data structures to make repeated processing more efficient. For example, the server maintains a rolling transcript buffer with indexed segments, so that frequent retrieval of the last N minutes of conversation does not require scanning the entire history. The server maintains emotion state time series for each participant using ring buffers, allowing efficient updates and queries without dynamic memory allocation for each time step. The server maintains a cache of previously generated support information and associated prompts, and when a new situation is similar to a recent one based on a similarity metric, the server reuses or adapts cached outputs instead of generating new ones from scratch. These techniques further reduce latency and computational load.

In one variation, the server executes the emotion estimation module using a compact neural network specifically designed for resource-limited environments. The network may be a small transformer with fewer layers or a lightweight convolutional architecture. The server may quantize weights and activations to reduce memory and speed up computation on general-purpose processors. This improves scalability and allows deployment on distributed edge servers.

In another variation, the server does not directly fine-tune the generative AI model, but instead learns a policy that selects between a plurality of predefined prompt templates. The server uses a reinforcement learning algorithm to adjust selection probabilities based on cumulative user approval. This technique allows the system to adapt its behavior without modifying the underlying large model parameters, which can be advantageous in environments where direct model fine-tuning is restricted.

In yet another variation, the terminal includes additional sensors, such as wearable sensors for physiological signals. The terminal forwards these signals to the server, and the server incorporates these signals as features in the emotion estimation module. The server thereby refines the emotion state estimation and further adjusts the prompt sentences and support information to match users'physiological states. From a technical perspective, this additional modality enhances robustness of emotion estimation and reduces error rates compared to systems relying solely on text.

In all of these embodiments, the server and the terminal cooperate to implement a technical solution that goes beyond automation of human reasoning. The server internally implements a non-conventional combination of modules and specific data flows that improve the performance and behavior of the computing system itself. The described architectures support multiple domains including operation management of moving objects, business decision-making, production optimization, and advertising planning, while sharing core mechanisms of emotion-aware prompt generation, generative AI invocation, and feedback-based adaptation.

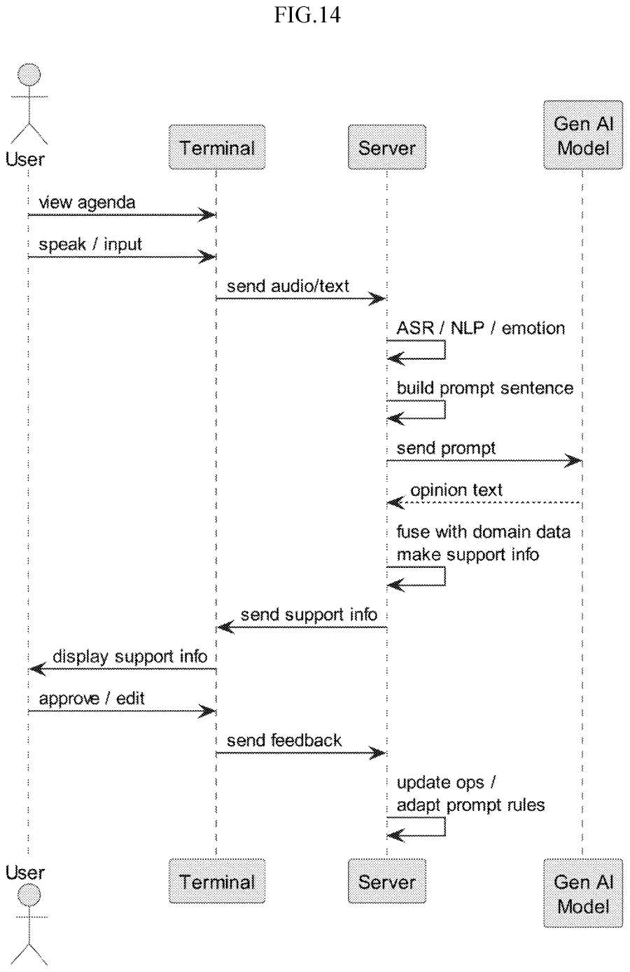

The following describes the processing flow using FIG. 14.

### Step 1:

Server acquires configuration data and agenda information.
Server receives, as input, meeting or discussion settings, including agenda items, domain type (for example, vehicle operation, business management, production, or advertising), and participant identifiers, from a configuration database or from a terminal request.
Server parses this input and stores it in internal data structures, such as an agenda table and a session context object. Server thereby generates, as output, a structured context record that will be referenced in subsequent processing.

### Step 2:

Terminal captures audio and video data from participants.
Terminal receives, as input, real-time signals from a microphone and optionally a camera. Terminal digitizes the audio into frames (for example, 16-bit PCM at 16 kHz) and encodes video into frames or short clips.
Terminal sends, as output, the encoded audio and video data to the server over a network connection using a streaming protocol or batched HTTP requests.

### Step 3:

Server performs speech recognition to obtain character data.
Server receives, as input, audio data segments from the terminal. Server segments the audio into fixed-length windows (for example, 5 seconds) and calls a speech recognition engine with each window.
Server uses a speech recognition algorithm to convert acoustic features into text, and receives recognized text and confidence scores. Server writes, as output, text records into a transcript table, each record including a timestamp, a participant identifier, and a text string.

### Step 4:

Server normalizes and indexes the transcript.
Server receives, as input, the raw transcript records from Step 3 and the agenda context from Step 1. Server applies natural language processing, including tokenization, normalization of case, and removal of non-informative symbols.
Server adds, as output, tokenized entries to a text index that maps each token to positions in the transcript, and creates a condensed transcript segment aligned with the current time window.

### Step 5:

Server estimates participants'emotional states.
Server receives, as input, the normalized text from Step 4, the original audio segments from Step 3, and optionally video frames from Step 2. Server extracts acoustic features (for example, Mel-frequency cepstral coefficients, pitch, energy) and textual features (for example, token sequences, sentiment indicators) and provides these as features to an emotion estimation model.
Server executes the emotion estimation model, which outputs probability values for a plurality of emotion classes per participant and per time interval. Server stores, as output, these emotion probabilities in an emotion state table keyed by participant and timestamp.

### Step 6:

Server selects relevant context segments based on agenda and emotion.
Server receives, as input, the agenda context from Step 1, the text index from Step 4, and the emotion state table from Step 5. Server identifies time intervals where emotion intensity exceeds a threshold or where agenda-related keywords occur.
Server extracts, as output, a context subset consisting of selected transcript fragments and corresponding emotion state summaries, and packages them into a context object to be used for prompt construction.

### Step 7:

Server generates a prompt sentence for the generative AI model.
Server receives, as input, the context object from Step 6 and the domain type from Step 1.
Server uses a template selection rule to choose an appropriate template for the domain (for example, route optimization, sales forecasting, production optimization, or advertising planning). Server fills template slots with recent transcript excerpts, summarized domain data, and emotion summaries.
Server produces, as output, a prompt sentence in natural language. For example, server may output:
“We provide the following transcript excerpt of a management meeting and a summary of participants'emotions. Act as a decision support assistant. Based on this context, generate a concise recommendation regarding the next quarter's product pricing. The transcript: [condensed transcript]. Emotion summary: [Participant A appears anxious; Participant B appears frustrated]. Provide a recommendation, and explain in two paragraphs how your proposal addresses these emotions.”

### Step 8:

Server acquires domain-specific operational data.
Server receives, as input, domain identifiers from the session context. For moving objects, server queries location sensors, navigation databases, and traffic information services. For business decisions, server issues SQL queries to databases to obtain historical sales, costs, and market indices. For production, server accesses machine logs and sensor streams. For advertising, server queries product and campaign repositories.
Server normalizes and aggregates these datasets into uniform data structures (for example, time-aligned arrays or key-value maps). Server outputs, as a result, a domain data bundle ready to be coupled with generative AI outputs.

### Step 9:

Server invokes the generative AI model with the prompt sentence.
Server receives, as input, the prompt sentence from Step 7, the domain data bundle from Step 8 (as a summarized text or encoded structure), and configuration parameters for inference (for example, temperature, maximum tokens). Server encodes the prompt as tokens and sends it to the generative AI model through a model interface.
Server receives, as output, a sequence of tokens representing generated text. Server decodes the tokens into character data to obtain opinion information, which may include recommendations, explanations, and ranked options.

### Step 10:

Server post-processes generative AI output and fuses it with domain data.
Server receives, as input, the opinion information from Step 9 and the domain data bundle from Step 8. Server parses the opinion information to identify structured elements, such as proposed parameters, routes, schedules, or campaign elements, using pattern matching or natural language parsing.
Server checks feasibility and consistency of these proposals against the domain data by executing deterministic algorithms, such as constraint checking or path evaluation. Server outputs, as a result, emotion-aware opinion information that is validated and enriched with numeric attributes such as estimated time, cost, or throughput.

### Step 11:

Server generates support information for domain-specific actions.
Server receives, as input, the enriched emotion-aware opinion information from Step 10 and the emotion state table from Step 5. Server applies rule-based logic or a secondary decision model to combine technical constraints with emotional considerations, for example selecting proposals that both satisfy efficiency thresholds and are likely to reduce negative emotions.
Server constructs, as output, support information that includes recommended actions, quantified benefits, potential risks, and guidance on how to communicate or implement those actions in light of participants'emotional states.

### Step 12:

Terminal presents support information and receives user input.
Terminal receives, as input, the support information from Step 11 via a network response. Terminal renders textual recommendations and associated visualizations, such as maps for moving objects, graphs for business metrics, timelines for production schedules, or mockups for advertising concepts.
Terminal outputs, as a result, a user interface that allows a user to approve, reject, or edit the proposed actions. Terminal collects the user's approval input or correction input through interactive controls and sends this feedback to the server.

### Step 13:

User evaluates the support information and provides feedback.
User receives, as input, the presented support information on the terminal display. User interprets maps, charts, and text to understand the implications of the proposed actions, and then decides whether to accept them, modify them, or request alternatives.
User generates, as output, an explicit action on the terminal, such as pressing an “Approve” button, selecting alternative parameters, or entering comments, which is transmitted back to the server as structured feedback data.

### Step 14:

Server updates domain operations based on user approval.
Server receives, as input, the approval or correction data from Step 13 and the underlying support information from Step 11. Server identifies the corresponding domain control endpoints, such as a vehicle control system, a business planning system, a production control system, or an advertising management system.
Server applies the approved changes by issuing control messages or configuration updates, thereby modifying actual routes, schedules, resource allocations, or campaign settings. Server records, as output, operation update logs that link each change to the underlying opinion information and user decision.

### Step 15:

Server records feedback and context for adaptation.
Server receives, as input, the user feedback from Step 13, the prompt sentence from Step 7, the generative AI output from Step 9, and the emotion states from Step 5. Server aggregates these elements into a feedback record containing fields such as session identifier, domain type, prompt template identifier, evaluation outcome, and emotion before and after the decision.
Server writes, as output, these feedback records into a feedback database, where they can be retrieved by the model-adaptation logic.

### Step 16:

Server adapts prompt generation and model behavior using feedback.
Server receives, as input, batches of feedback records from Step 15. Server analyzes correlations between prompt structures, emotion patterns, and user approvals using statistical measures and clustering algorithms. Server updates internal prompt templates and selection rules to favor configurations that historically yielded high approval rates and low correction frequencies.
Server outputs updated prompt generation parameters and, in some embodiments, updated model adapter weights or configuration settings, which are stored in configuration repositories and applied in subsequent executions of Steps 7 and 9, thereby improving the efficiency and accuracy of future opinion information generation.
The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.
Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.
For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.
The above exemplary embodiment gives an implementation example in which the specific processing is performed by the data processing device 12, however technology disclosed herein is not limited thereto, and the specific processing may be performed by the smart device 14.

### Second Exemplary Embodiment

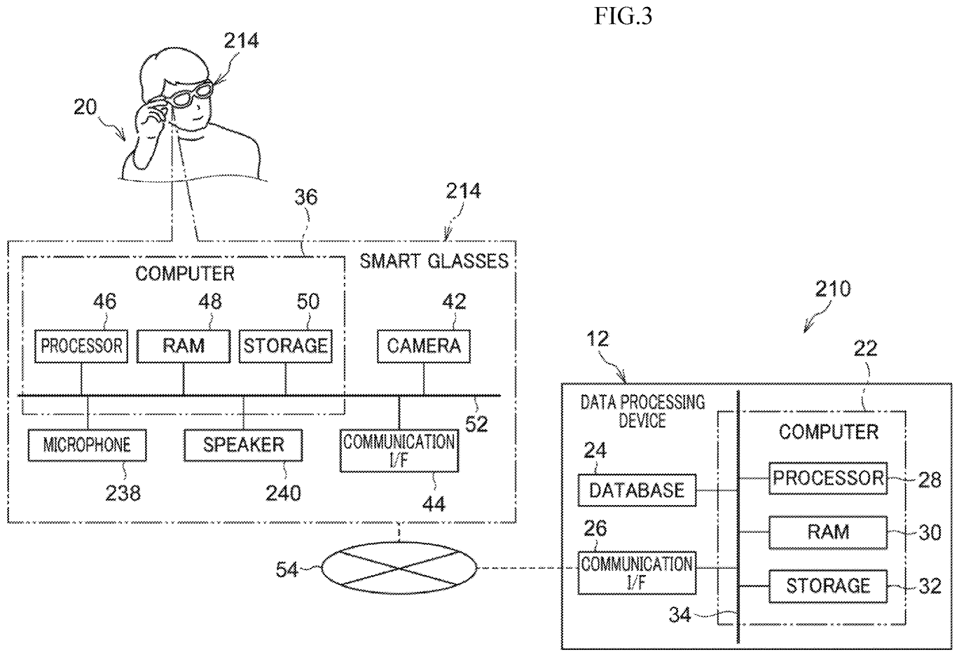

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

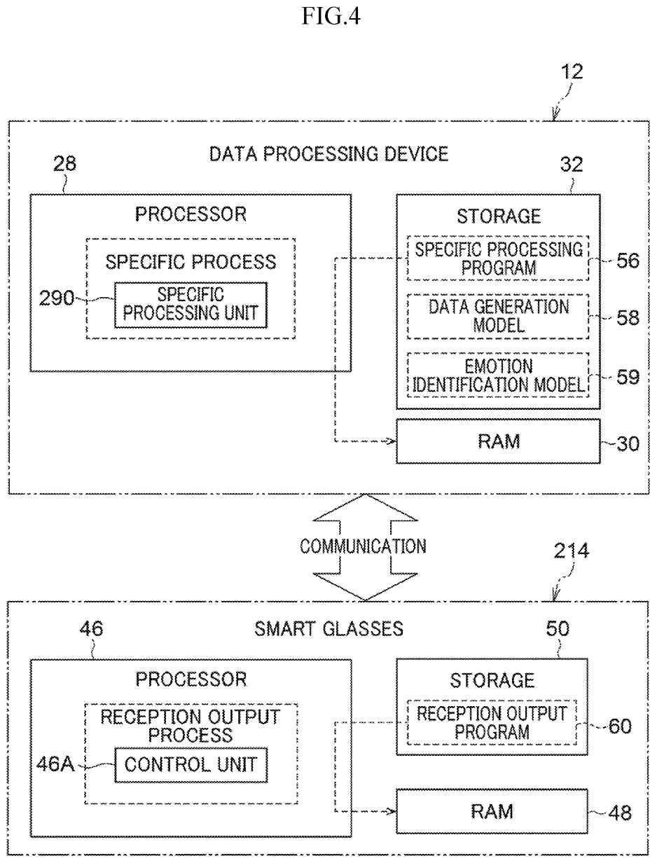

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

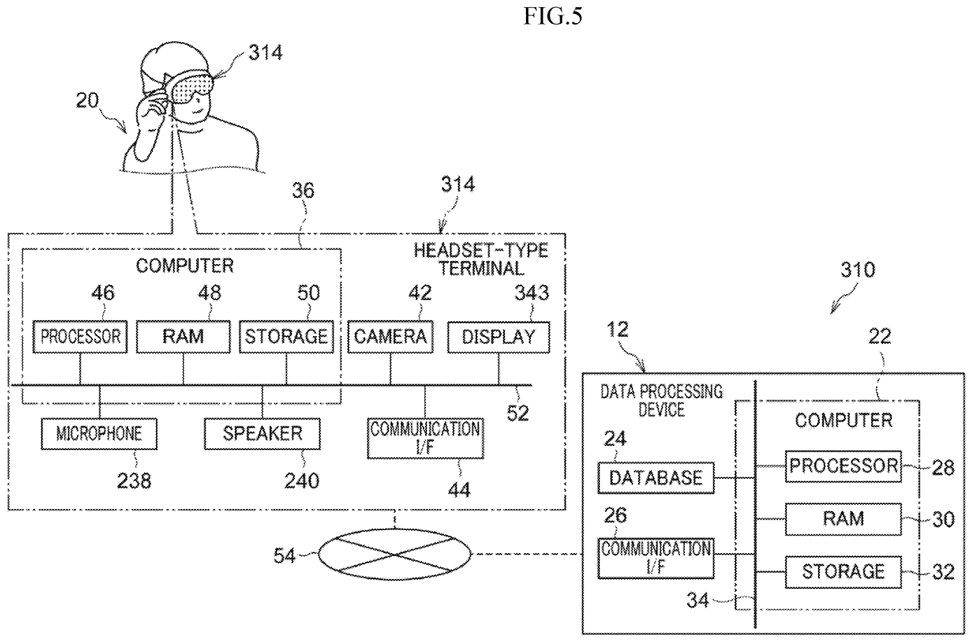

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

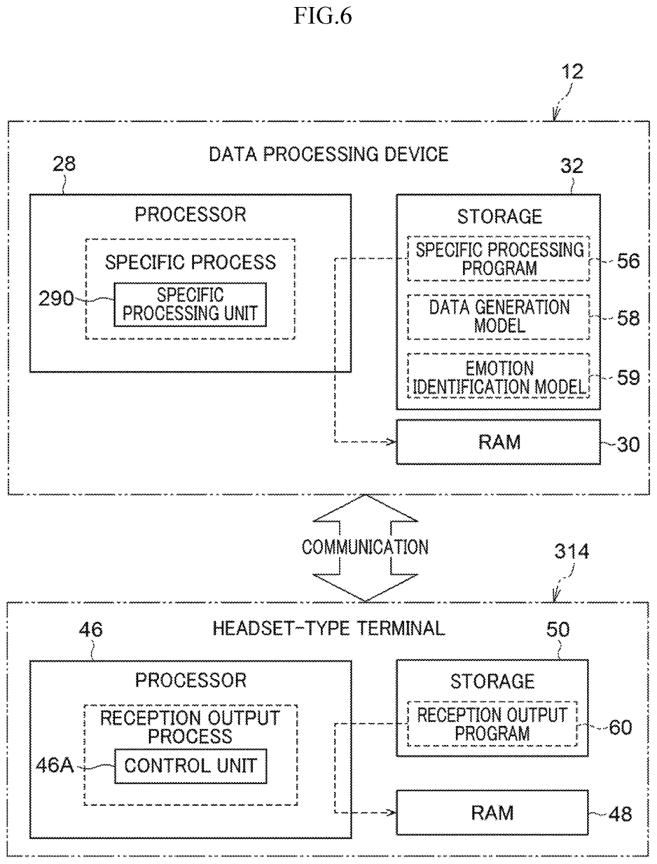

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

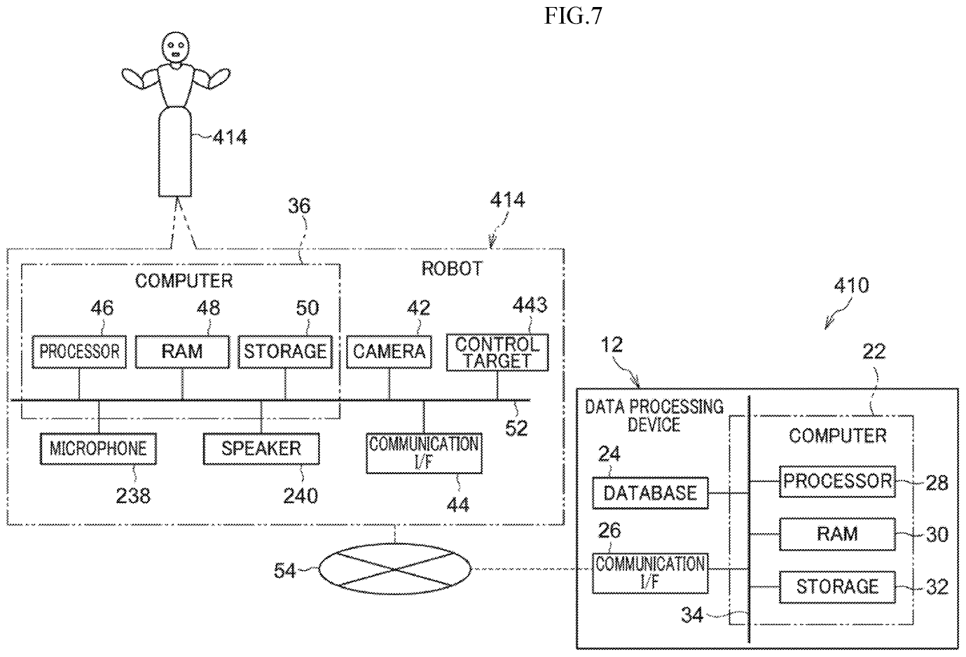

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

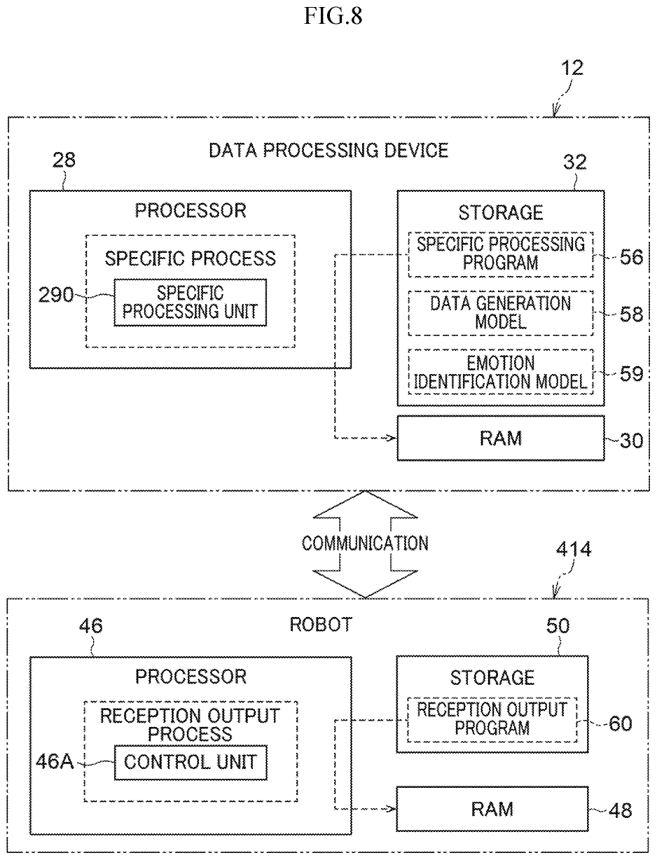

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

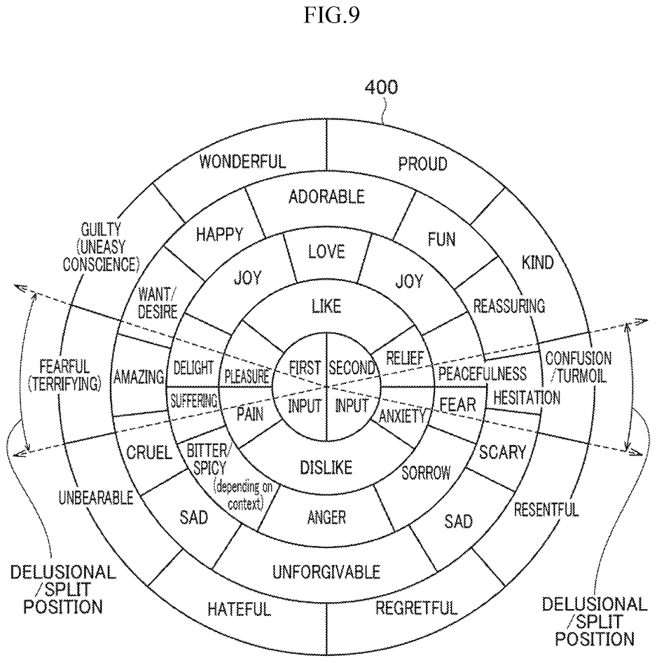

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

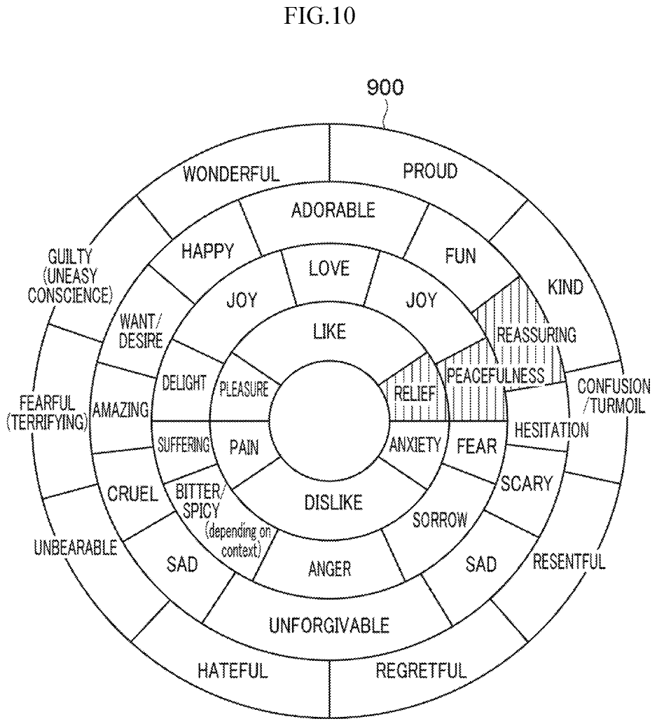

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

### Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
summarize meeting information and extract important terms based on an agenda and discussion content of a meeting, and generate a prompt sentence including the summarized information and the important terms, the prompt sentence being used to instruct a generative information processing apparatus to generate an opinion; and
acquire voice information and handwriting information, convert the acquired voice information and handwriting information into character information, and use the character information as the meeting information for construction of the prompt sentence; and
transmit the prompt sentence including the agenda, the discussion content, the summary, and the important terms to an external generative information processing apparatus, and provide opinion information, which is obtained from the external generative information processing apparatus, to participants of the meeting; and
dynamically update the prompt sentence during progress of the meeting based on an additional instruction sentence input from a terminal by a user, and obtain additional opinion information corresponding to the additional instruction sentence from the external generative information processing apparatus; and
analyze an emotional state of the participants of the meeting, and add an analysis result of the emotional state to the prompt sentence so as to instruct the external generative information processing apparatus to generate the opinion information in consideration of the emotional state; and
store the prompt sentence and the opinion information as recording information on a per-meeting basis, and reuse the recording information for construction of the prompt sentence in a subsequent meeting.

### (Supplementary 2)

The system according to supplementary 1,
wherein the processor is configured to
receive input of the discussion content of the meeting from a management organization via a terminal, and automatically acquire the meeting information by obtaining the voice information of the meeting through an acoustic processing apparatus and applying voice recognition technology to the voice information.

### (Supplementary 3)

The system according to supplementary 1,
wherein the processor is configured to
output the opinion information generated by the external generative information processing apparatus and result information of the meeting to an external information providing apparatus as external transmission information, in order to add topicality and obtain a sales effect.

### Application Example 1

### (Supplementary 1)

A system comprising a processor,
wherein the processor is configured to
generate a prompt sentence for a generative AI model based on agenda information of a meeting and state information of a managed domain so as to cause the generative AI model to generate an opinion and an operation plan, and
acquire audio data from an acoustic input device or a recording medium and convert the audio data into character data, and extract utterance content and an emotional state of a meeting participant from the character data, and
generate, by the generative AI model, an opinion relating to meeting management based on the extracted emotional state of the meeting participant and the agenda information of the meeting, and perform preprocessing on time-series data acquired from the managed domain and input the preprocessed time-series data to the generative AI model to generate the operation plan relating to the managed domain, and
acquire data indicating an operating state from a detection device installed in the managed domain, store the data in a storage device, and aggregate and normalize the data at predetermined time intervals to convert the data into an input format for the generative AI model, and
transmit the operation plan output from the generative AI model to a terminal device and present the operation plan as schedule information visually displayable on the terminal device and as opinion information representing a rationale of the operation plan, and receive, via the terminal device, an edited operation plan edited by a user, verify an editing content, determine the edited operation plan as a final operation plan, and generate and transmit execution instruction information for a control device of the managed domain based on the determined final operation plan, and
record a difference between the operation plan and the final operation plan, regenerate the prompt sentence for the generative AI model based on new time-series data from the managed domain and the difference, and update the operation plan continuously.

### (Supplementary 2)

The system according to supplementary 1,
wherein the processor is configured to
generate the prompt sentence by summarizing, together with the agenda information of the meeting, recent operating results, abnormal events, requirement conditions, and constraint conditions in the managed domain, and including a natural-language description of the summary in the prompt sentence to be input to the generative AI model.

### (Supplementary 3)

The system according to supplementary 1,
wherein the processor is configured to
cause the schedule information and the opinion information transmitted to the terminal device to be presented in a format in which an edit history can be retained in response to an operation by the user, and store the edit history as learning data used for training of the generative AI model or for adjustment of inference conditions of the generative AI model.

### Example 2

### (Supplementary 1)

A system comprising a processor,
wherein the processor is configured to
generate a prompt sentence as an instruction text including meeting character information and constraint conditions, the prompt sentence being configured to instruct a generative AI model to generate opinions and proposals in accordance with an agenda of a meeting and a progress state of the meeting,
receive meeting audio information transmitted from an information acquisition terminal via a communication network, store the meeting audio information as an acoustic signal, and convert the acoustic signal into meeting character information by using a speech recognition function,
extract a predetermined range of the meeting character information, and incorporate the extracted meeting character information into the prompt sentence to format input data to be supplied to the generative AI model,
transmit, to the generative AI model, the input data including the prompt sentence and the meeting character information, and generate opinion information including summary information of the meeting and specific action plans based on an analysis result acquired from the generative AI model,
transmit the opinion information in a predetermined information format to a meeting participant user terminal, and support decision-making in the meeting by causing the meeting participant user terminal to display the opinion information,
estimate an emotional state of a meeting participant based on utterance content and responses of the meeting participant, and dynamically change content of the prompt sentence or an expression format of the opinion information in accordance with the emotional state, and record the meeting character information and the opinion information in association with each meeting, and reconfigure recorded contents as comprehensive report information after the meeting is finished.

### (Supplementary 2)

The system according to supplementary 1,
wherein the processor is configured to control the information acquisition terminal that has an audio input/output function and a display function, such that the information acquisition terminal starts acquisition of the meeting audio information in response to a user operation at a start of the meeting, divides the acquired meeting audio information into segments for each predetermined time unit, and sequentially transmits the divided meeting audio information to the system via the communication network, and
wherein the processor is configured to generate the meeting character information for each piece of the divided meeting audio information, and automatically generate the input data to the generative AI model and update the opinion information when an accumulated amount of the meeting character information exceeds a predetermined amount.

### (Supplementary 3)

The system according to supplementary 1,
wherein the processor is configured to format the opinion information acquired from the generative AI model as structured information including at least summary information of the meeting, pro and con information for each discussion point, risk information, and recommended execution timing, and output a part or all of the structured information to an information distribution apparatus that is viewable by a user outside a meeting body, thereby providing a meeting outcome a externally sharable information.

### Application Example 2

### (Supplementary 1)

A system comprising a processor,
wherein the processor is configured to
generate a prompt sentence for a generative AI model, the prompt sentence being generated based on agenda information of a meeting or other discussion, and being configured to instruct the generative AI model to generate opinion information,
acquire audio data representing speech in the meeting or other discussion, and convert the audio data into character data by performing speech recognition processing, analyze an emotional state of one or more participants of the meeting or other discussion by performing emotion estimation processing based on at least the character data and the agenda information, and, in accordance with the emotional state, adjust content of at least one of the prompt sentence to be input to the generative AI model and opinion information obtained from the generative AI model, thereby generating emotion-aware opinion information,
acquire at least one of operation information of a moving object, business information of an organization, operation information of a production environment, and information relating to advertising, and combine the acquired information with the emotion-aware opinion information and the emotional state to generate support information relating to at least one of operation management of the moving object, business decision-making, production optimization, and advertising planning,
present the support information to an output device or a display device, receive an approval input or a correction input from a user with respect to the support information, and, in accordance with the approval input or the correction input, update at least one of the operation management, the business decision-making, the production optimization, and the advertising planning, and
update, based on at least one of the support information, the approval input or the correction input, and the emotional state, a generation method of the prompt sentence for the generative AI model or learning information for the generative AI model so as to improve accuracy of generation of the opinion information in subsequent processing.

### (Supplementary 2)

The system according to supplementary 1,
wherein the processor is configured to include, in acquiring the audio data, at least one of an input process in which content of the meeting or other discussion is input by an information management entity via a terminal device, and an input process in which the content of the meeting or other discussion is automatically acquired by the speech recognition processing.

### (Supplementary 3)

The system according to supplementary 1,
wherein the processor is configured to transmit at least one of the generated opinion information, the support information, result information of the meeting or other discussion, and activity information relating to use of the generative AI model as a decision-making entity to an external information providing apparatus, and to output the transmitted information to an external destination as public-relations information for generating public interest and producing effects in business activities.

What is claimed is:

1. A system comprising:
circuitry configured to:
receive, via a communication interface coupled to a packet-switched network, meeting information including agenda data and discussion content from a terminal device, summarize the meeting information and extract important terms, and store the meeting information in a storage device;
generate a structured prompt sentence incorporating the summarized meeting information and the extracted important terms, input the prompt sentence to a generative AI model, and obtain opinion information including at least summary information, pros and cons analysis, and proposed action plans from the generative AI model; and
analyze emotional states of participants based on audio data or text data received from the terminal device via the communication interface, incorporate the analyzed emotional states into the generated opinion information, and transmit the opinion information to the terminal device via the communication interface.

2. The system according to claim 1, wherein the circuitry is configured to receive voice information and handwriting information from the terminal device via the communication interface, convert the voice information and the handwriting information into text data, and generate character information representing the discussion content from the converted text data.

3. The system according to claim 2, wherein the circuitry is configured to perform natural language processing on the character information to extract the important terms, and generate the structured prompt sentence incorporating at least the agenda data, the extracted important terms, and an instruction for the generative AI model to generate opinion information.

4. The system according to claim 3, wherein the circuitry is configured to tokenize the structured prompt sentence according to a vocabulary of the generative AI model, configure model parameters, and transmit the tokenized prompt sentence to an inference engine to obtain the opinion information.

5. The system according to claim 4, wherein the circuitry is configured to decode output from the inference engine, parse the decoded output to extract structured fields including summary information, pros and cons data, risk descriptions, and specific action plans, and store the structured fields as opinion information in the storage device.

6. The system according to claim 1, wherein the circuitry is configured to analyze the emotional states of participants by applying an emotion analysis engine to voice data received from the terminal device, detect emotional tone indicators in the voice data, and incorporate the emotional tone indicators into the structured prompt sentence.

7. The system according to claim 6, wherein the circuitry is configured to adjust at least one of a tone, an emphasis, and a content selection of the opinion information based on the analyzed emotional states of the participants.

8. The system according to claim 1, wherein the circuitry is configured to receive real-time audio data from the terminal device during a meeting session via the communication interface, continuously update the character information based on the received audio data, and regenerate the structured prompt sentence as the meeting progresses.

9. The system according to claim 8, wherein the circuitry is configured to detect a change in the meeting agenda during the meeting session based on the updated character information, and update the structured prompt sentence to reflect the detected agenda change.

10. The system according to claim 1, wherein the circuitry is configured to store the structured prompt sentence, the opinion information, and the emotional state data in the storage device in association with a meeting identifier, and retrieve stored information for subsequent meeting follow-up processing.

11. The system according to claim 10, wherein the circuitry is configured to generate a follow-up prompt sentence incorporating stored opinion information and action plans from a previous meeting, input the follow-up prompt sentence to the generative AI model, and obtain updated action item status for transmission to the terminal device.

12. The system according to claim 1, wherein the circuitry is configured to generate a plurality of opinion variants by generating a plurality of prompt sentences with different instruction settings, evaluate the opinion variants based on relevance scores, and transmit the highest-ranked opinion variant to the terminal device.

13. The system according to claim 1, wherein the circuitry is configured to detect participant contribution patterns from the audio data, identify participants who have not contributed to the discussion, and incorporate the contribution pattern information into the prompt sentence to generate balanced opinion information.

14. The system according to claim 1, wherein the circuitry is configured to receive handwriting input data from the terminal device representing notes taken during the meeting, convert the handwriting input data into text, and incorporate the converted text into the meeting information stored in the storage device.

15. The system according to claim 14, wherein the circuitry is configured to integrate converted handwriting text with converted voice text to generate a unified discussion record, and use the unified discussion record as input to the structured prompt sentence for the generative AI model.

16. The system according to claim 1, wherein the circuitry is configured to generate a visualization of the opinion information and the action plans, format the visualization as display data, and transmit the display data to the terminal device for presentation during or after the meeting.

17. The system according to claim 16, wherein the circuitry is configured to update the visualization in real time based on newly generated opinion information received from the generative AI model during the meeting session.

18. A system comprising:
circuitry configured to:
receive, via a communication interface coupled to a packet-switched network, meeting information including agenda data and discussion content from a terminal device, and store the meeting information in a storage device;
generate a structured prompt sentence incorporating summarized meeting information and extracted important terms, input the prompt sentence to a generative AI model, and obtain opinion information including summary information, pros and cons analysis, and proposed action plans;
analyze emotional states of participants based on audio data received from the terminal device via the communication interface, and incorporate the analyzed emotional states into the generated opinion information; and
transmit the opinion information to the terminal device via the communication interface, and store the opinion information in the storage device in association with a meeting identifier.

19. The system according to claim 18, wherein the circuitry is configured to receive real-time audio data from the terminal device during a meeting session, continuously update the character information based on the received audio data, and regenerate the structured prompt sentence as the meeting progresses to obtain updated opinion information.

20. A method comprising:
receiving, via a communication interface coupled to a packet-switched network, meeting information including agenda data and discussion content from a terminal device, summarizing the meeting information and extracting important terms, and storing the meeting information in a storage device;
generating a structured prompt sentence incorporating the summarized meeting information and the extracted important terms, inputting the prompt sentence to a generative AI model, and obtaining opinion information from the generative AI model; and
analyzing emotional states of participants based on audio data or text data received from the terminal device via the communication interface, incorporating the analyzed emotional states into the generated opinion information, and transmitting the opinion information to the terminal device via the communication interface.
